(19) United States
(12) Patent Application Publication
(10) Pub. No.: US 2024/0149434 A1
(43) Pub. Date: May 9, 2024

(54) EXTREMITY-SUPPORTING DEVICE, AND METHOD FOR LIFTING, HOLDING AND/OR CARRYING A LOAD AND/OR FOR PERFORMING OVERHEAD ACTIVITIES

(71) Applicant: FRAUNHOFER-GESELLSCHAFT ZUR FÖRDERUNG DER ANGEWANDTEN FORSCHUNG E.V., München (DE)

(72) Inventors: Jonas SCHIEBL, Stuttgart (DE); Christophe MAUFROY, Stuttgart (DE)

(73) Assignee: FRAUNHOFER-GESELLSCHAFT ZUR FÖRDERUNG DER ANGEWANDTEN FORSCHUNG E.V., München (DE)

(21) Appl. No.: 18/549,442

(22) PCT Filed: Mar. 11, 2022
(86) PCT No.: PCT/EP2022/056399

§ 371 Date: Sep. 7, 2023

(30) Foreign Application Priority Data
Mar. 12, 2021 (DE) 10 2021 202 433.5

(51) Int. Cl. B25J 9/00; A61H 3/00

(52) U.S. Cl. CPC B25J 9/0006; A61H 3/00; A61H 2003/007; A61H 2201/018; A61H 2201/1215; A61H 2201/1481; A61H 2201/1619; A61H 2201/1635; A61H 2201/165; A61H 2201/5053; A61H 2201/5058; A61H 2205/062

(57) ABSTRACT

The invention relates to an extremity-supporting device for supporting the movement of an extremity of a user, in which the degree of support offered by a passive actuator can be adjusted by means of an active actuator.

The invention relates to an extremity support device for supporting the movement of an extremity of a user during which the degree of support, which is effectuated by a passive actuator, can be set by way of an active actuator.

Musculoskeletal disorders (MSDs) represent a high percentage of work-related illnesses and are the cause of high costs due to lost productive time. Frequently, these result from physical strain, such as hard physical labor. Exoskeletons and assistance systems worn on the body have the potential to reduce the resulting physical stresses and thereby provide relief for the user. A number of so-called passive exoskeletons exist to support overhead working, during which stresses pass through the shoulders and the back. For example, these lift the upper arm by way of a pretensioned spring, helping to reduce stress on shoulder muscles. Forces are in part conducted by mechanical connections all the way to the hip, whereby relief can often also be provided to the back. Passive exoskeletons can thus offer great support during quasi-static work when the wearer carries out only small movements with the arms (for example in a small movement range above shoulder height). Problems, however, occur when the desired support is to be changed (for example because a larger or small load is acting on the wearer from the outside, such as during a tool change) or during more dynamic activities having larger ranges of movement. In this case, the wearer has to move his or her arms downward, against the supporting force of the exoskeleton, which is unpleasant, is an impairment in the long run and, especially in the case of larger degrees of support, can at times be very strenuous, thereby diminishing the advantage of the stress reduction of an exoskeleton.

The problem was able to be reduced for overhead work, for example, in that mechanical adjustment mechanisms were provided. These can either pretension the spring elements and/or change a lever arm to a point of the acting force in such a way that the supporting force becomes larger or smaller. In addition, mechanisms exist in which the wearer is able to uncouple the springs when these are not tensioned (arms up), whereby the resulting supporting force is minimized (quasi deactivation of the system). However, in these solutions, the degree of support cannot be adapted (or can only be adapted with great difficulty) while working.

To ensure that the desired support occurs during lifting, without resistance occurring when the arms are being lowered, research is being conducted worldwide on active support systems. Motors are activated in the process and transmit a required torque during lifting, while providing no or only little resistance when the arms are being lowered. However, thus far only isolated active system haves managed to enter the market, which may be due to several reasons: The motors require a lot of space and are heavy due to the high required power density. In addition, these must be permanently activated so as to respond to movements of the users, which increases the power consumption, and thereby also the weight of the energy infrastructure worn on the body (for example rechargeable batteries). Moreover, these drives are usually located in the region of the shoulder. This positioning is far away from the body's center of gravity, which raises the input of torques into the body, and increases the overall weight in that more substantial mechanical connections are needed between the drive and the hip so as to transmit forces and moments. Moreover, safety concerns continue to play a major role since driving torque is dependent on the electrical current that is fed (which may possibly vary). In the worst case, the support may thus be stronger than the user himself or herself and may force movements on him or her.

It is the object of the present invention to provide an extremity support device and a method carried out using this device, which allows the degree of support to be adjusted rapidly with little energy expenditure and preferably overcomes the aforementioned disadvantages of the prior art.

This object is achieved by the extremity support device according to claim 1 and by the method for lifting, holding and/or carrying a load and/or for carrying out overhead activities according to claim 34. The respective dependent claims provide advantageous refinements of the extremity support device according to the invention and of the method according to the invention.

The invention relates to an extremity support device for supporting an extremity of a user. The support can preferably take place while lifting, holding and/or carrying a load and/or while carrying out overhead activities. Optionally, it is also possible that a movement of the extremity is supported. The extremity support device can support one or more extremities of the user. Possible extremities can be one arm or both arms and/or one leg or both legs of the user.

The extremity support device comprises an extremity engagement unit, which is configured to engage on the extremity of the user. The extremity engagement unit can, for example, be an arm attachment or an arm engagement unit or a leg attachment or a leg engagement unit. If an arm is supported, the extremity engagement unit can, for example, include a concavely curved portion, in which the arm of the user can be placed from above, and which is then able to upwardly support the arm, that is, in a direction against the gravitational force.

The extremity engagement unit can also completely enclose the extremity. For this purpose, the extremity engagement unit can comprise two concavely curved portion-shaped elements, for example, the concave depressions of which can have the shape of a cylinder partial surface, and the cylinder axes of which can extend parallel or coaxially with respect to one another. In addition, the extremity engagement unit can also comprise or consist of straps or strap systems.

The extremity support device furthermore comprises an extremity lever, to which the extremity engagement unit is connected via an engagement connecting element. The engagement connecting element can comprise one or more sub-elements. In a simple case, the engagement connecting element can be a joint via which the extremity engagement unit is connected to the extremity lever. A joint axis of this joint can be oriented so as to sit perpendicularly on a longitudinal direction of the extremity lever and extend through the extremity when the same is arranged in the extremity engagement unit. In another simple case, the engagement connecting element can, for example, be a prismatic joint, which allows a relative movement in the extremity lever direction. Combinations of several different joints or passive degrees of freedom are possible here.

The engagement connecting element can also be one or more pull force transmission elements, such as cable pulls, chains and/or belts, for example, by way of which a force can be transmitted from the extremity lever to the extremity engagement unit. This can in particular be advantageous when the extremity is a leg of the user.

The extremity support device furthermore comprises a swivel joint about which the extremity lever can be rotated. The swivel joint can be arranged at an optional torso module, for example, so that the extremity lever can then be rotated about the swivel joint relative to the torso module. If the extremity is an arm of the user, it is advantageous when the swivel joint is positioned close to the shoulder, and particularly preferably a rotational axis of the swivel joint points through the glenohumeral joint of the user. However, it is also possible for the swivel joint to be arranged in front of or behind the same, thereabove or therebeneath, depending on the specific use of the extremity support device.

The extremity support device furthermore comprises a pull transmission element, which engages on the extremity lever on a side that is located opposite the engagement connecting element in relation to the swivel joint. This may be understood to mean that the pull transmission element engages on the extremity lever in such a way that a force exerted thereby on the extremity engagement unit or the engagement connecting element is oriented against the force exerted by the pull transmission element. For example, a pull transmission element that engages downwardly on the extremity lever could cause the extremity to be pushed upwardly. It shall be noted that this feature does not imply that the pull transmission element engages directly on the extremity lever, and also not that the rotational axis of the swivel joint extends through the extremity lever. For example, the pull transmission element can engage on the extremity lever via an intermediate element. The extremity lever can also be connected to the swivel joint via another intermediate element. Even if the axis of the swivel joint does not intersect the extremity lever or the progression of the longitudinal axis thereof, a force that is exerted in a certain direction by the pull transmission element is to cause a force on the extremity engagement unit which acts in the opposite direction. This shall be considered to be equivalent to the statement that the pull transmission element engages on the extremity lever on a side of the extremity lever which is located opposite the engagement connecting element in relation to the swivel joint.

Instead of stating that the pull transmission element engages on the extremity lever, it is also possible to state that the pull transmission element acts on the extremity lever. The pull transmission element can engage on the extremity lever or act thereon directly or mediated by further intermediate elements. The sides of the extremity lever can optionally also be distinguished by a plane in which the rotational axis of the swivel joint is located and which is perpendicular to a longitudinal direction of the extremity lever. The longitudinal direction of the extremity lever can, for example, be defined as the direction in which the extremity lever has the largest extension. Advantageously, the pull transmission element can be attached to the extremity lever on the side of the extremity lever which is located opposite the engagement connecting element or the extremity engagement unit in relation to the swivel joint.

The extremity support device furthermore comprises a spacer element, which limits, in at least one direction, a distance between the pull transmission element and the swivel joint at the point of contact of the pull transmission element with the spacer element. In optional embodiments, the pull transmission element can also engage directly on the spacer element. In this optional case, the spacer element can limit the distance between one end of the pull transmission element and the swivel joint in both directions.

The extremity support device furthermore comprises a control mechanism by way of which a distance between the spacer element and the swivel joint can be varied. The distance between the spacer element and the swivel joint shall hereafter be referred to as the spacer element distance. The spacer element can thus be moved by means of the control mechanism for varying the spacer element distance. The control mechanism comprises a control actuator, by way of which a force for varying the spacer element distance can be exerted on the spacer element. In simple optional embodiments, the control mechanism can be the control actuator.

The spacer element distance influences or determines the degree of support that the extremity support device provides to the extremity. As a result, the degree of support can be set by way of the spacer element distance. Since the spacer element distance can be set by way of a control actuator, the degree of support can be adapted quickly and automatically to the work situation of the user.

The control actuator is preferably an active actuator, the force action of which can be controlled. The control actuator can preferably be automatically controlled or controllable. For this purpose, the control actuator can, for example, be connected to a control unit, for example an electronic control unit, which actuates the control actuator automatically and/or based on user input.

In an advantageous embodiment of the invention, one end of the pull transmission element, which does not engage on the extremity lever, can engage on a passive actuator, which is configured to exert a pulling force on the pull transmission element. The passive actuator can, for example, comprise or be one or more springs. It is then possible to transmit the pulling force from the passive actuator to the extremity lever by way of the pull transmission element.

A pull transmission element here shall be understood to mean an element by way of a pulling force can be transmitted, preferably a pull force and no push and/or no shear forces. If, for example, the pull transmission element is a cable or a belt, this can only transmit pull forces, but no shear forces and no pressure forces. If, on the other hand, the pull transmission element is a chain, the transmission of pressure forces may also be possible. All that matters for the invention is that primarily pulling forces can be transmitted.

In one advantageous embodiment of the invention, the extremity support device can comprise a torso module, which is configured to engage on the torso of the user. It is particularly advantageous when the torso module can engage on the pelvis of the user. The module may then also be referred to as a pelvic module. In principle, however, the torso module may also engage on other regions, for example, it may be worn by the user using shoulder straps or be attachable in another manner to the torso of the user. If the torso module engages on the pelvis, it may advantageously be configured so as to at least partially enclose the pelvis, and particularly advantageously bear on the pelvis. The torso module may be regarded as a fixed point of the extremity support device, so that the extremity lever can be rotatable about the swivel joint in relation to the torso module. Further elements and joints may be provided between the swivel joint and the torso module.

Advantageously, the extremity support device can comprise a guide element, along which the spacer element can be moved to vary the spacer element distance. The guide element may thus guide the spacer element. The guide element may be fixed and/or fixable in relation to the control mechanism and/or possibly in relation to the torso module. As an alternative or in addition, the guide element may also be configured in such a way that the extremity lever can be rotated about the swivel joint with respect to the guide element. In this case, the guide element can thus also be regarded as a fixed point of the extremity support device.

In an advantageous embodiment, the guide element can be connected to the control mechanism via a joint. This joint shall hereafter be referred to as a guide joint. The guide joint can particularly preferably comprise a locking device, by way of which a rotation of the guide element about the guide joint can be locked, whereby, for example, the angle of the guide element with respect to the torso module can be varied and adjusted.

The guide element can particularly preferably comprise or be a rail or groove in which the spacer element or by which the spacer element is guided. The rail can be straight or curved, and preferably can be monotonically curved. A monotonic curvature here shall be understood to mean a curvature that does not change direction. Particularly preferably, the curvature can be strictly monotonic so as not to include any straight sections. The progression of the rail, however, can also change the curvature thereof. The rail can advantageously include two elongated holes or grooves that extend parallel to one another, between which the spacer element is arranged, and the spacer element can, on opposing sides, in each case comprise a pin, a block or a roll, which engage in the respective elongated hole or the respective groove.

The guide element allows a path to be predefined, along which the spacer element moves when the spacer element distance is being varied. In this way, the profile of the angle-dependent (dependence of the angle of the extremity lever with respect to the torso module) degree of support can be predefined upon actuation by the actuator. In particular, it is possible to adapt the profile of the degree of support to the application in which the extremity support device is used. For example, it is thus possible to predefine that the degree of support initially changes during a displacement of the spacer element so that the angle-dependent (dependence of the angle of the extremity lever with respect to the torso module) degree of support behaves as if the angle of the extremity lever with respect to the torso module were small, and later as if this angle were large. It is likewise possible to predefine any other profile of the degree of support.

In an advantageous embodiment of the invention, the spacer element can limit the distance between the pull transmission element and the swivel joint in the direction away from the swivel joint. This means that the pull transmission element can move away from the swivel joint until it meets the spacer element and, at the site at which the pull transmission element makes contact with the spacer element, is then prevented by the spacer element from moving further away from the swivel joint. For this purpose, the spacer element can be situated on the side of the pull transmission element which faces away from the swivel joint. In this case, it is preferable when a force can be exerted on the spacer element by the control mechanism in the direction toward the swivel joint. This force can thus effectuate a change in the spacer element distance in the direction toward the swivel joint. The force exerted by the control mechanism thus preferably acts against to the force that the pull transmission element exerts on the spacer element when the spacer element prevents the pull transmission element from moving further away from the swivel joint.

Generally speaking, directions away from an element shall denote those directions along which the distance with respect to the element increases. Accordingly, directions in the direction of an element shall be directions along which the distance with respect to the element decreases. The directions do not necessarily have to be radial with respect to the element, that is, it is not mandatory for them to intersect the element or extend directly toward the same.

As an alternative or in addition to the aforementioned embodiment, the spacer element can also limit the distance between the pull transmission element and the swivel joint in the direction of the swivel joint. It is then advantageous when, as an alternative or in addition, the force for varying the spacer element distance which can be exerted by the control mechanism on the spacer element can be exerted in the direction away from the swivel joint. This embodiment is in particular advantageous when the extremity lever, on the side comprising the extremity engagement unit or the engagement connecting element, can include a very small angle with a connecting element, which can connect the torso module and the swivel joint, or with the control mechanism, since the pull transmission element then moves closely to the swivel joint on the opposite side. In this way, a very small angle would arise between the pull transmission element and the extremity lever, whereby the torque exerted by the pull transmission element on the extremity lever would become very small. If the pull transmission element is held at the spacer element at a certain minimum distance with respect from the swivel joint, this prevents the angle between the pull transmission element and the extremity lever to drop below a certain level. In this way, it is possible to ensure that the torque does not become too small. It is advantageous in the process when the spacer element is held in both directions, as will be described below.

In an advantageous embodiment of the invention, the pull transmission element can comprise a first pull transmission sub-element and a second pull transmission sub-element. The pull transmission sub-elements can be individual elements transmitting a pulling force, which together represent the pull transmission element, or may also be sections of the pull transmission element. If, for example, the pull transmission element is a cable pull, a chain or a belt, the pull transmission elements can also simply be different sections of the cable pull, of the belt or of the chain.

In this embodiment, it is advantageous when the first and second pull transmission sub-elements pass the spacer element on opposite sides. It is particularly preferred when the first and second pull transmission elements are each dimensioned in such a way that at least one of the pull transmission sub-elements makes contact with the spacer element in any position of the extremity lever about the swivel element. In this way, it can also be prevented that the torque exerted by the pull transmission element on the extremity lever becomes too small in the case of very small angles between the control mechanism or the connecting element, which can connect the torso module and the swivel joint, and the extremity lever. The idea is that, as long as the angle between the control mechanism and the extremity lever or connecting element is large, the pull transmission sub-element running between the spacer element and the swivel joint makes contact with the spacer element, and that, when the angle becomes smaller, the pull transmission sub-element, located opposite the swivel element in relation to the spacer element, makes contact with the spacer element. This element then has a larger angle with respect to the extremity lever, whereby the torque can be prevented from becoming too small.

Advantageously, the spacer element can in each case comprise one roll for each direction in which it limits the distance between the pull transmission element and the swivel joint. The pull transmission element can make contact with the respective roll, with the same limiting the distance, on the side which is opposite the direction in which the respective roll limits the distance between the pull transmission element and the swivel joint. In simplified terms, in this case the pull transmission element can run between the swivel joint and the spacer element when the spacer element limits the distance in the direction away from the swivel joint, and can run past the spacer element on the outside when the spacer element limits the distance in the direction of the swivel joint.

A rotational axis of the respective roll is preferably parallel to the rotational axis of the swivel joint. Generally speaking, it is preferred when the direction in which the spacer element distance can be varied is perpendicular to the rotational axis of the swivel joint. The pull transmission element preferably runs in directions that are perpendicular to the rotational axis of the swivel joint. The longitudinal direction of the extremity lever, the pull transmission element and the direction of the displacement of the spacer element for varying the spacer element distance as well as the spacer element distance itself preferably extend in a plane on which the rotational axis of the swivel joint is perpendicularly situated.

In an advantageous embodiment of the invention, the swivel joint can be fixedly connected to the control mechanism via a connecting element, which can be configured so as to run along the torso of the user when the user wears the extremity support device as intended. The connecting element can advantageously have an elongated shape, and particularly preferably can have a straight design. The connecting element does not have to run parallel to the torso. If the connecting element has a straight design, the connecting element can, for example, include an acute angle with a straight line that is parallel to the spinal column of the user. If a torso module is provided, the connecting element can thus be arranged with one side at the torso module, preferably by way of one or more joints. The joints can enable a rotation of the connecting element in relation to the torso module about one, two or three rotational axes. Optionally, the connecting element can also be rotatable about the longitudinal axis thereof, or an axis that extends along the torso of the user. The swivel joints make it possible for the user to be able to freely move the supported extremity in the angular degrees of freedom that are not supported.

The extremity support device can advantageously be configured to support two of the extremities of the user, for example both arms. In this case, the extremity support device can comprise the aforementioned elements for each extremity, that is, in particular the extremity engagement unit, the engagement connecting element, the swivel joint, the pull transmission element, the spacer element, and the control mechanism including the control actuator. If a torso module is provided, the components for each extremity are preferably arranged at the same torso module. An extremity support device that supports two of the extremities thus preferably has exactly one torso module. If one arm is supported, or if both arms are supported, the respective connecting element preferably engages on the torso module on the side and/or on the rear. If both arms are supported, the torso module can thus be arranged between the two connecting elements for the two arms.

If the pull transmission element is connected to a passive actuator, as described above, the passive actuator can likewise be arranged at the connecting element, preferably at the end thereof which faces away from the extremity lever. Particularly preferably, a swivel joint or ball joint can be provided between the connecting element and the passive actuator. In this way, the passive actuator can follow the pull transmission element when this element changes the distance thereof with respect to the swivel joint.

In an advantageous embodiment, the control actuator can be arranged at the extremity lever. The control actuator is then preferably arranged on the same side in relation to the swivel joint as the extremity engagement unit or the engagement connecting element. A force action direction of the control actuator is then preferably parallel to the longitudinal direction of the extremity lever at the site where the control actuator is arranged. In this embodiment, the pull transmission element can be attached to the spacer element and end there. In this embodiment, the spacer element can be displaceable along the extremity lever and, for example, be arranged therein. The spacer element can, for example, be guided in a guide rail, which runs in the extremity lever and optionally is situated parallel to the longitudinal direction thereof. In this embodiment, the control actuator can also be directly connected to the spacer element. In this way, a movable part of the control actuator would be connected to the spacer element, that is, the part that, upon actuation, is linearly moved with respect to the extremity support device or the extremity lever.

In an advantageous embodiment, the control actuator can comprise a rotary drive and a spindle shaft that can be rotated by way of the rotary drive, which is also referred to as a threaded spindle. A spindle nut, which can run on the spindle shaft, can be arranged on the spindle shaft. The spindle nut is thus displaced on the spindle shaft by a rotation of the rotary drive. The force on the spacer element can then be effectuated by the spindle nut.

For this purpose, the spacer element can be connected to the spindle nut directly or via mediating elements. Such a control actuator allows the spacer element distance to be controlled very precisely.

In an advantageous embodiment of the invention, the control actuator can comprise a rotary drive and a spindle shaft, which are arranged next to one another and with rotational axes parallel to one another and which are kinematically connected to one another via a gear mechanism. Due to the fact that the rotary drive and the shaft are arranged next to one another, the necessary length of the control mechanism can be decreased.

The control mechanism can preferably comprise at least one elastic element, for example a spring element, which is arranged so as to be deflectable by the control actuator and cause a force that is oriented against to the force that can be exerted by the control actuator and causes the change in the spacer element distance. The elastic element can thus be arranged and configured so as to be deflectable by the force action of the control actuator against the restoring force thereof, that is, can be tensioned, for example in the case of a tension spring, or compressed, in the case of a compression spring. Preferably, the at least one elastic element, on the one hand, can be connected to the element of the control actuator which is linearly moved by actuation of the actuator and, on the other hand, can end at a component that carries the swivel joint and/or is fixed in relation to the swivel joint. Particularly preferably, the elastic element and/or the direction of the force action thereof can be situated parallel to the longitudinal direction of the above-described connecting element, if such a connecting element is provided. Particularly advantageously, two or more of the elastic elements are provided, which are arranged so as to be located opposite in relation to a straight line along which the linearly movable part of the control actuator moves, and the shared resulting force action line of which is preferably located on a straight line with the force action line of all resulting forces on the linearly movable part of the control actuator (for example, forces that are caused by a rotation of the spindle or by forces of the control pull elements (19) on the movable part of the control actuator). This way, a moment action, and thus tilting of the control actuator, can be prevented. In particular, it is advantageous when the end of the elastic element which is not connected to the control actuator is fixedly connected to the connecting element, if such a connecting element is provided. Providing such an elastic element allows a certain degree of support to be set by the actuation of the actuator, and the associated displacement of the spacer element, and allows this setting to be canceled very quickly and without further energy expenditure since the force action of the elastic element is sufficient to do so. When the force action of the control actuator is canceled, the at least one elastic element causes the spacer element to return to the original state. If the actuator, as described above, is configured as a spindle shaft including a spindle nut, one end of the at least one elastic element can preferably be attached to the spindle nut.

In an advantageous embodiment of the invention, the control actuator can comprise a rotary drive and a linearization mechanism, by way of which torque effectuated by the rotary drive can be transformed into a linear force for varying the spacer element distance. The above-described embodiment comprising a spindle shaft and spindle nut is an example of this. The control actuator particularly preferably furthermore comprises a coupling by way of which the transformation of the torque into the linear force can be established and released. Such a coupling makes it possible to move the spacer element into a certain position by way of the control actuator, and thereby set a certain degree of support. The support can then simply be ended by releasing the coupling. The spacer element can then return into the original position thereof under the action of, for example, the elastic elements, without the rotary drive having to be rotated in the process. In this way, a very rapid return can be achieved. The coupling is particularly advantageously connected to at least one of the elastic elements since this element can move the spacer element back against to the deflection by the control actuator counter when the coupling is being opened.

The control mechanism can advantageously comprise at least one blocking element, by way of which the spacer element distance can be blocked. This blocking element can be used, for example, in such a way that initially the spacer element is moved to a desired spacer element distance as a result of the force action of the control actuator, and then the blocking element is activated so as to fix the spacer element distance. In the event that the blocking element does not require energy (for example permanent magnetic brake) in the blocking state, the spacer element distance, and thus the degree of support, can be fixed, without having to expend energy to do so, whereby the entire system can be supported with a defined degree of support, without consuming energy. The control actuator can thus be deactivated. So as to move the spacer element back into an original position, it is sufficient to release the blocking element and optionally release the coupling, if necessary. The spacer element can move back into the original state thereof on its own under the action of the force by the at least one elastic element or, in the simplest case, by the pull transmission element.

In an advantageous embodiment of the extremity support device according to the invention, the control mechanism can comprise a first control pull transmission element. A control pull transmission element shall be understood to mean an element that is able to transmit at least pulling forces and, in optional embodiments, also exclusively pulling forces. It is thus optionally possible for the control pull transmission element to also transmit pressure forces; however, this is not necessary. For example, cables and chain-like connections also exist, which can also transmit minor pressure forces, which may be advantageous. The first control pull transmission element described here can be connected at one end to the control actuator in such a way that a pulling force can be exerted by the control actuator on this first control pull transmission element. At the opposite end thereof, the first control pull transmission element can be contacted with the spacer element in such a way that the force for varying the spacer element distance can be exerted on the spacer element by way of the first control pull transmission element. Optionally, the first control pull transmission element, during the progression thereof from the control actuator to the spacer element, can pass at least one deflection element, at which it can change the direction of the progression thereof, particularly preferably in the direction of the spacer element. It is advantageous, but not necessary, for the first control pull transmission element to directly change the direction of the progression thereof toward the spacer element. It is also possible for the element to only bring the progression thereof closer to the direction toward the spacer element and, during the further progression, to be guided by, for example, further deflection elements in the direction of the spacer element. The deflection element or deflection elements can, for example, be rollers over which the control pull transmission element runs. Such a control pull transmission element allows the control actuator to be freely positioned. In particular, it is not necessary for the control actuator to act in the direction in which the spacer element is to be displaceable. This embodiment is particularly advantageous when the control actuator, with the linear force action direction thereof, is parallel to the above-described connecting element.

In an advantageous embodiment, the control pull transmission element can comprise a cable pull or a strand, which runs in a Bowden cable sheath in at least a portion of the progression thereof. As a result, the control actuator can be arranged substantially arbitrarily on the body of the user. The force for varying the spacer element distance with respect to the spacer element can then be transmitted via the control pull transmission element, preferably in the form of a pulling force. If a guide element is present, the control pull transmission element preferably engages on the spacer element in such a way that the cable or the strand runs parallel to the direction of the guide element at the point of engagement. The control pull transmission element can advantageously engage on the spacer element from the side facing the swivel joint and/or the side facing away from the swivel joint. By way of the Bowden cable sheath, the element can be guided to the corresponding side. In this embodiment, the control actuator can advantageously be arranged at the back of the user when the extremity support device is used as intended, preferably at the height of the hip or back. Alternatively, however, the device can also be arranged, for example, at the stomach or at a leg of the user.

The cable or the strand can advantageously also be guided in sections in a Bowden cable sheath and, in other sections, can be guided over one or more rollers, by which the progression is deflected.

The control mechanism can advantageously comprise a further control pull transmission element, which is likewise connected to the spacer element, but on a side located opposite the first control pull transmission element. In this way, the further control pull transmission element can exert a pulling force on the spacer element, which is oriented against the pulling force exerted by the first control pull transmission element. Together, the first and further control pull transmission elements can displace the spacer element in both directions along the spacer element distance, and can preferably hold it in a defined position. The further control pull transmission element is advantageously connected to the control actuator in such a way that a pulling force that is oriented against the pulling force that can be exerted on the first control pull transmission element can be exerted on the further control pull transmission element by the control actuator. When the linearly movable element of the control actuator is thus moving in one direction, the actuator pulls on one of the two control pull transmission elements, and when the actuator is moving in the opposite direction, it pulls on the other of the two control pull transmission elements. The further control pull transmission element, during the progression thereof from the control actuator to the spacer element, preferably passes at least one further deflection element, and particularly preferably two further deflection elements, at which the further control pull transmission element changes the direction of the progression thereof in the direction of the spacer element. What was said with regard to the first control pull transmission element applies analogously here. As a result of the further control pull element, it is possible to pull the spacer element in both directions and then hold it in a fixed position. It shall be noted that the first and further control pull transmission elements can also be implemented as parts of a shared, annularly closed control pull transmission element.

In an advantageous embodiment of the invention, the control actuator can comprise a rotary drive and at least one roll that can be rotated by the rotary drive. The first and/or the further control pull transmission elements, if present, can be attached to a surface of the roll or to surfaces of a respective roll, so that these can be wound onto the roll by a rotation of the roller and/or unwound from the roll. If in each case a roll is provided for each control pull transmission element, these are preferably arranged on a shared axis and are rotated jointly. Advantageously, the at least one roll can be connected via a coupling to the rotary drive, by which a transmission of torque from the rotary drive to the roll can be released and established. It is also possible here, by releasing the coupling, to achieve that the spacer element moves back into the original position thereof by itself, possibly under the action of the at least one elastic element, without having to also rotate the rotary drive.

In advantageous embodiments of the invention, it may be possible for the spacer element to be fixedly arranged directly at the control actuator. The spacer element can be fixedly arranged at the movable part of the control actuator, that is, the part that is able to carry out a linear movement. In this way, it is possible to implement embodiments comprising few components, which are thus more cost-effective. The spacer element being fixedly arranged directly at the control actuator shall be understood to mean that no elements that are movable in relation to the spacer element and the control actuator are provided between the spacer element and the control actuator. If the spacer element is configured as a roll, a rotational axis of this roll can be fixed in relation to the movable part of the control actuator in this embodiment.

In an advantageous embodiment of the invention, the control mechanism can comprise a bevel gear connection. A first bevel gear can be drivable therein by the control actuator, which in this case can be a rotary drive. A second bevel gear can be connected to a shaft, which can be connected to a spindle shaft (threaded spindle), the rotation of which allows the force for varying the spacer element distance to be exerted on the spacer element. The shaft itself can also be a spindle shaft. For this purpose, the spacer element can comprise a spindle nut, for example in the interior thereof or connected thereto, which is in engagement with the spindle shaft. A rotational axis of the first bevel gear is advantageously parallel or coaxial to a rotational axis of the control actuator, while a rotational axis of the second bevel gear is parallel to the direction in which the spacer element can be displaced for varying the spacer element distance.

In an alternative embodiment, the control mechanism can comprise a universal joint connection, by way of which the force for varying the spacer element distance can be transmitted from the control actuator to the spacer element. The control actuator preferably again comprises a rotary drive for this purpose, which effectuates a rotation of a shaft connected to a part of the universal joint. Another part of the universal joint can be connected to a shaft which rotates a spindle on which the spacer element can be displaceable. The shaft itself can also be a spindle shaft. The spacer element can also be configured as a spindle nut here, which can run on the spindle shaft. The first shaft can be coaxial or parallel to the rotational axis of the rotary drive, while the second shaft can be parallel to the direction in which the spacer element can be displaced.

In a further embodiment of the invention, the control mechanism can comprise a gear wheel, which can be driven by the control actuator, and additionally a toothed rack in which the gear wheel engages. The control actuator can also again comprise a rotary drive, by way of which the gear wheel can be rotated. The toothed rack can be connected to the spacer element so that the force for varying the spacer element can be transmitted by the toothed rack to the spacer element. In this embodiment, it is advantageous when the direction in which the spacer element can be displaced for varying the spacer element distance is perpendicular to the rotational axis of the rotary drive.

In a further alternative embodiment of the invention, the control mechanism can comprise a worm gear drivable by the control actuator, as well as a worm shaft in which the worm gear engages. It is also advantageous here when the control actuator comprises a rotary drive that drives the worm gear. The worm shaft can be connected to the spacer element so that the force for varying the spacer element distance can be transmitted by the worm shaft to the spacer element. In this embodiment of the invention, it is likewise advantageous when the direction in which the spacer element moves for changing the spacer element distance is perpendicular to the rotational axis of the rotary drive. At the same time, the worm shaft is also again a spindle shaft here, as was the case, for example, in the variant comprising the bevel gear. The force and the linear movement are then again generated by a spindle nut from the rotation.

When the control actuator generates a linear force, such as, for example, the above-described control actuator comprising a rotary drive, a spindle shaft that can be rotated by the rotary and a spindle nut running on the spindle shaft, the extremity support device can also comprise a chain made of at least two links connected to one another via connecting joints, of which a first of the links engages on the linearly movable part of the control actuator, for example on the spindle nut, and a last of the links engages on the spacer element. It is particularly advantageous when the links at the connecting joints are each guided in at least one rail. The rail can, for example, be implemented in the form of two parallel elongated holes or grooves, between which the joint is arranged and in which pins or shafts arranged coaxially with respect to the joint axis engage. The links are advantageously designed as elongated straight elements, and the connecting joints are designed as swivel joints, the joint axes of which are perpendicular to the longitudinal direction of the links. The described rails can then likewise extend perpendicular to the axis of the connecting joints. This embodiment allows both a pulling force and a pressure force to be exerted on the spacer element by the spindle nut of the control actuator. It is thus sufficient to connect the spacer element on one side to the chain of links, which here can be regarded as the control pull transmission element. Particularly advantageously two of the links are provided, one being connected to the spindle nut via a swivel joint, and the other being connected to the spacer element via a swivel joint. The connecting joint between the two links can be mechanically guided in a rail, which may extend toward the guide element by which the spacer element is guided. The connecting joint is then displaced in the direction of the guide element when the spacer element is displaced away from the swivel joint.

In an advantageous embodiment, the control actuator can comprise a hydraulic cylinder, by way of which the force for varying the spacer element distance can be generated. Such a hydraulic cylinder can advantageously be arranged at or in the extremity lever. The hydraulic cylinder can preferably be oriented in such a way that a direction in which a hydraulic piston of the hydraulic cylinder is moving is parallel to the extremity lever or parallel to the guide element.

The extremity support device can advantageously comprise a displacement element arranged at the extremity lever. The pull transmission element can be fixedly connected at one of the ends thereof to the displacement element. Advantageously, the displacement element can be displaceable at the extremity lever in a plane that is perpendicular to the rotational axis, along a longitudinal direction of the extremity lever, and/or in a direction perpendicular to the longitudinal direction of the extremity lever and can be fixable in a certain position. For this purpose, rails or other guide elements, for example, can be provided at the extremity lever in the corresponding directions. In this way, it is possible to set a force range in which the support device is able to act and also influence the profile of the angle-dependent supporting force. If, for example, the displacement element is moved closer to the swivel joint, the supporting force becomes smaller, and if it is moved further away from the swivel joint, the supporting force becomes larger.

Advantageously, the spacer element distance, and thus the degree of support, can be adjusted, for example, by means of a switch and/or a slide controller. When the user operates the switch or the slide controller, he or she thereby activates or deactivates the control actuator, and releases possibly present blocking elements and/or couplings, thereby adjusting the degree of support.

It is also possible for the extremity support device to comprise, for example, a proximity sensor, a force sensor and/or a pressure sensor, which are configured to detect a weight of a load to be picked up. The control mechanism can then be configured to adjust the spacer element distance based on the detected weight. For this purpose, a control device can be provided, for example, which detects the weight by way of the corresponding sensor and accordingly activates the control actuator. For example, an RFID transceiver can be provided as the proximity sensor, which reads the weight, for example, from an RFID chip, which can be arranged at the load.

It is also possible for the extremity support device to comprise a muscle signal sensor, which can be used to measure activity signals of at least one muscle of the extremity that is to be supported by way of the extremity support device. The control mechanism can then be configured to set the spacer element distance based on the measured activity signal. If, for example, high muscle activity is measured, a high degree of support can be set.

In one embodiment of the invention, the extremity can be an arm, and the extremity support device can thus be an arm support device or a shoulder support device.

The pull transmission element and/or the control pull transmission element can comprise or be at least one cable and/or one chain and/or at least one belt. Generally, all elements by way of which in particular pulling forces can be transmitted may be used.

In an advantageous embodiment of the invention, the extremity lever can also comprise an adjustment element by means of which the distance between the extremity engagement unit and the swivel joint can be varied. Such an adjustment element can be a lockable telescopic connection, for example, the one half of which is connected to a swivel joint, and the other half of which is connected to the extremity engagement unit. It may be possible for the halves to be displaced inside one another. This telescopic connection can also be used without locking, whereby an additional passive prismatic degree of freedom of movement can be imparted to the system, for example to prevent constraint forces.

According to the invention, furthermore a method for lifting, holding and/or carrying a load and/or for carrying out overhead activities is provided. A user wears an extremity support device according to any one of the preceding claims. With support from the extremity support device, the user lifts this load, holds it and/or carries it and/or carries out an activity with his or her hands raised above the height of the head or shoulders.

The spacer element distance prior to and/or while lifting, holding or carrying and/or carrying out the activity with the hands raised above the height of the head is advantageously set to a first value in the process. Thereafter, the user lifts the load, holds it, carries it and/or carries out the activity with the hands raised above the height of the head. The user then sets the load down and/or ends the activity with the hands raised above the height of the head, and the spacer element distance is set to a second value, which is smaller than the first value. In an advantageous embodiment, the second value can also be a complete deactivation of the support. For this purpose, the spacer element distance can be reduced to a minimum value, which reduces the torque exerted by the pull transmission element to zero.

An advantageous embodiment of the method is one in which the control actuator is activated, for example has a voltage applied thereto, while the spacer element value is set to the first value, and is deactivated for setting the second value, for example in that the voltage is shut off. As a result, no energy whatsoever is needed for setting the spacer element distance to the second value. The resetting to the second value can be effectuated or supported, for example, by the elastic elements.

If the control actuator, as described above, comprises a rotary drive, a linearization mechanism by way of which a torque effectuated by the rotary drive can be transformed into the force for varying the spacer element distance, and a coupling by way of which the transformation of the torque into the force can be established and released, it is advantageously possible, before the spacer element distance is set to the first value, to establish, by way of the coupling, the transformation of the torque into the force between the rotary drive and the spacer element, and the transformation of the torque into the force by the coupling can be released for setting the spacer element to the second value. The at least one elastic element can also support the resetting to the second value here.

If the control mechanism, as described above, comprises a blocking element, the spacer element distance can be fixed thereby. The blocking element is opened before the spacer element distance is set to the first value, and the spacer element distance is fixed by way of the blocking element after the spacer element distance has been set to the first value. The blocking element is released again for setting the spacer element distance to the second value. The at least one elastic element can also support the setting to the second value here. Advantageously, the control actuator can comprise the rotary drive, the linearization mechanism and the coupling, as described above, as well as the blocking element. Before the spacer element distance is set to the first value, the transformation of the torque into the force between the rotary drive and the spacer element can then be established by way of the coupling. After the spacer element distance has been set to the first value, the spacer element distance can be fixed by way of the blocking element. The blocking element and the coupling can be released for setting the spacer element distance to the second value. The setting to the second value can, in turn, be supported or effectuated by the at least one elastic element.

Specifically, the following exemplary procedures are possible. If neither a blocking element nor a coupling nor an elastic element is provided, the spacer element distance can be set to the first value in that the control actuator is activated. As a result of the control actuator remaining activated, the spacer element distance can be maintained at the first value. For setting to the second value, the servo drive can actively move the spacer element to the second value. If the control actuator is an electrical control actuator, a corresponding voltage can be applied to the control actuator, both for setting the spacer element to the first value and for setting it to the second value.

If neither the blocking element nor the coupling is provided, however at least one of the elastic elements is provided, the spacer element distance can be actively set to the first value by activating the servo drive, in the case of an electrical servo drive, for example, by applying a voltage. The motor can remain activated for maintaining the spacer element distance at the first value. For setting the second value, the motor can then be deactivated, for example by shutting off the voltage. The at least one elastic element then effectuates the displacement of the spacer element to the second spacer element distance.

If no blocking element is present, however the coupling and the at least one elastic element are provided, the coupling can be activated for setting the spacer element distance to the first value, that is, a force transmission can be established and the motor can be activated. The motor can remain activated, and the coupling can remain activated, for maintaining the spacer element at the first spacer element distance. The coupling can then be released for setting the spacer element distance to the second value, so that the force transmission between the rotary drive and the linearization mechanism is canceled. The motor can be deactivated. By releasing the coupling, the spacer element can move to the second spacer element distance, without the rotary drive of the control actuator also being moved.

If the extremity support device does not comprise any elastic elements, but does comprise the blocking element, the blocking element can be deactivated, and the control actuator can be activated, for setting the first value of the spacer element distance. The blocking element can then be activated for maintaining the spacer element distance at the first value, while the control actuator can be deactivated. The blocking element can be opened or deactivated for setting the spacer element to the second value. The control actuator can then actively change the spacer element distance to the second value. If the extremity support device comprises the at least one elastic element, and moreover comprises the blocking element, the control actuator can be activated for setting the spacer element distance to the first value, the blocking element can be activated, and the control actuator can be deactivated, for maintaining the spacer element distance at the first value, and the servo drive, supported by the at least one elastic element, can displace the spacer element to the second spacer element distance, with the blocking element being open, for the resetting to the second value.

All of the above-described procedures can also be reversed, that is, the first spacer element distance and the second spacer element distance can be interchanged. Moreover, at least one of the two spacer element distances can in each case be continuously adjustable in a predefined range.

The invention will be described hereafter by way of example based on several figures. The features described in the figures can also be implemented independently of the specific example and be combined between the examples. Identical reference numerals denote identical or corresponding features.

In the drawings:

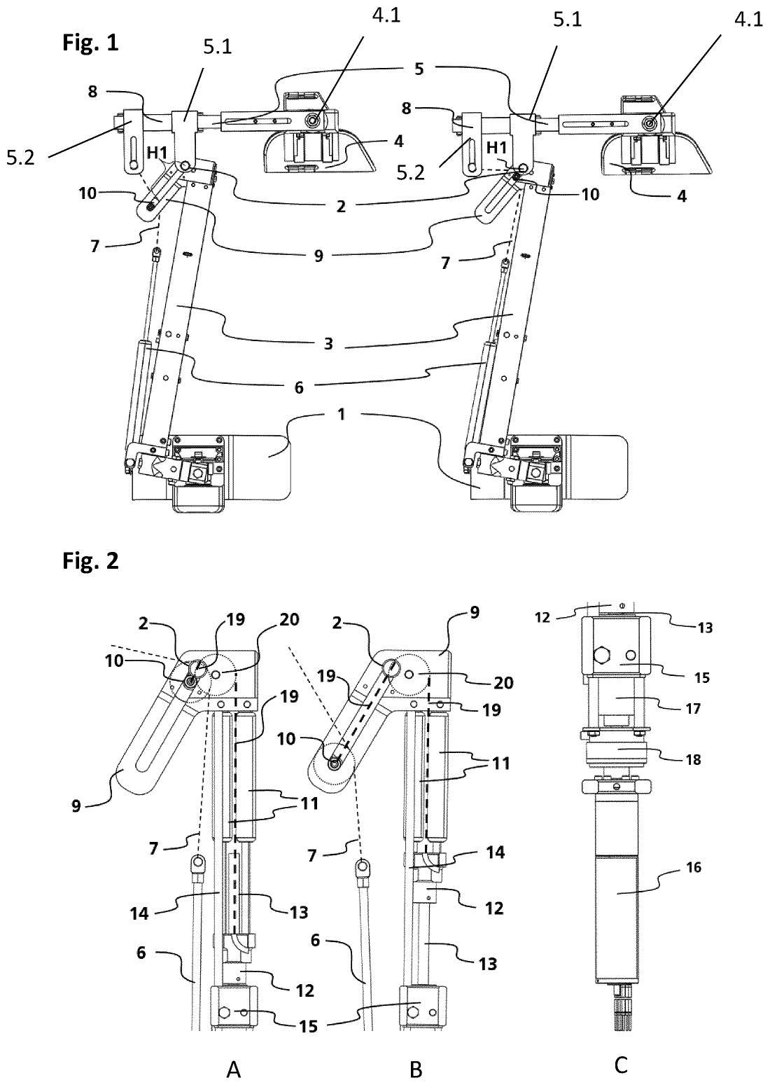

FIG. 1 shows an exemplary design of an extremity support device according to the invention;

FIG. 2 shows an embodiment of a control mechanism;

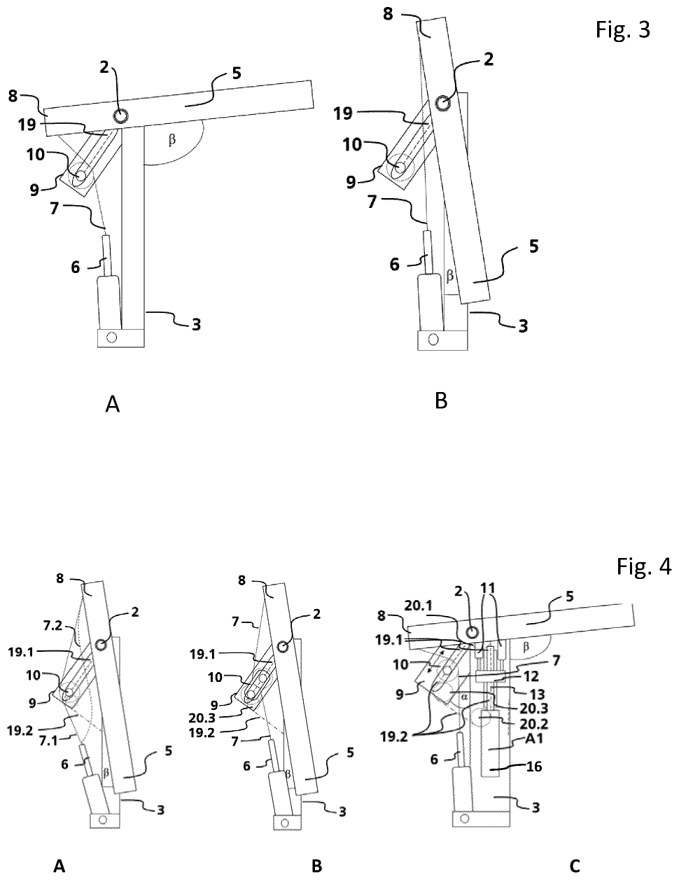

FIG. 3 shows a schematic illustration of the changed progression of the pull transmission element at different angles of the extremity lever;

FIG. 4 shows exemplary embodiments of the extremity support device;

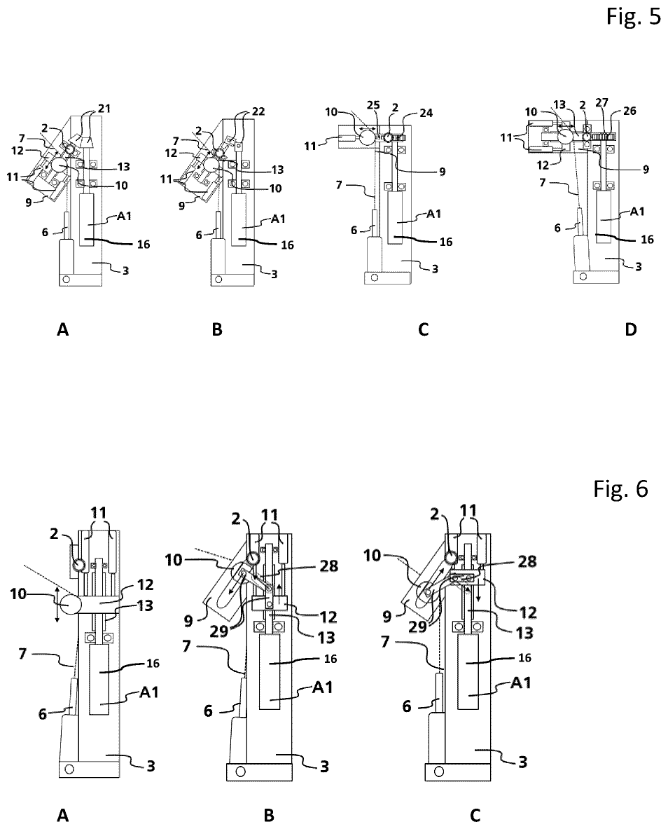

FIG. 5 shows exemplary embodiments of the control mechanism;

FIG. 6 shows further exemplary embodiments of the control mechanism;

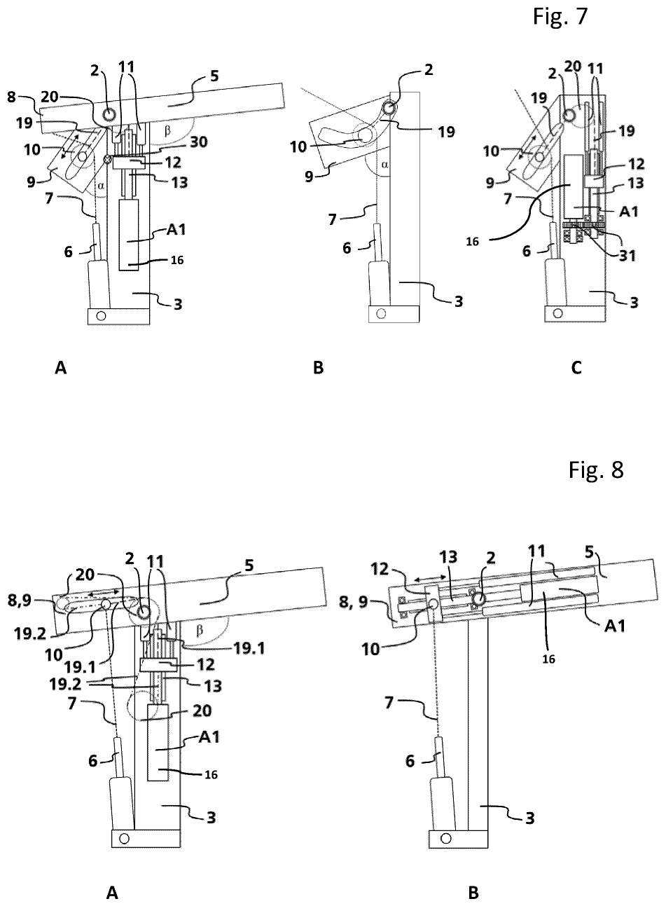

FIG. 7 shows further exemplary embodiments of the control mechanism;

FIG. 8 shows further exemplary embodiments of the control mechanism;

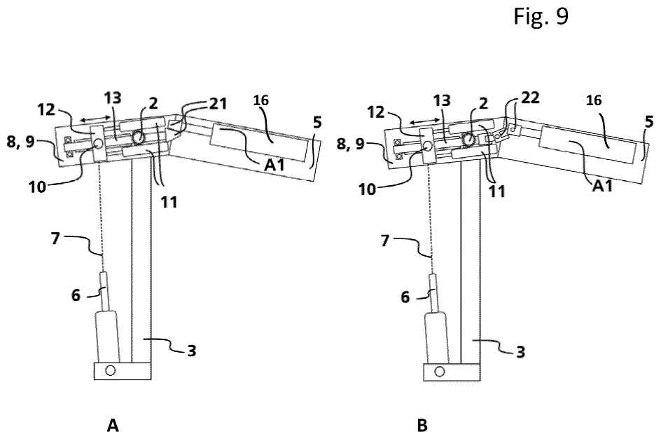

FIG. 9 shows further embodiments of the control mechanism according to the invention;

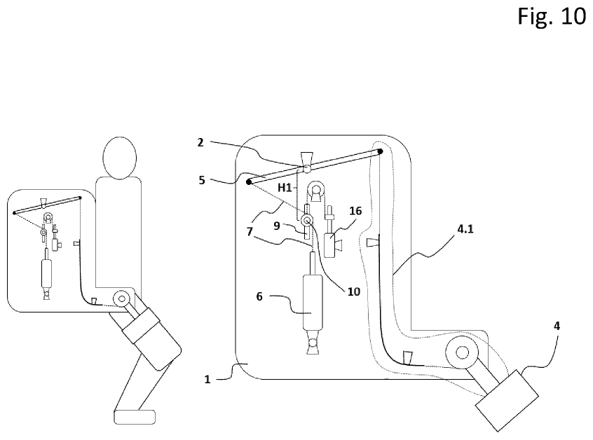

FIG. 10 shows, by way of example in a schematic illustration, an embodiment of the extremity support device according to the invention for the case that legs are the supported extremity;

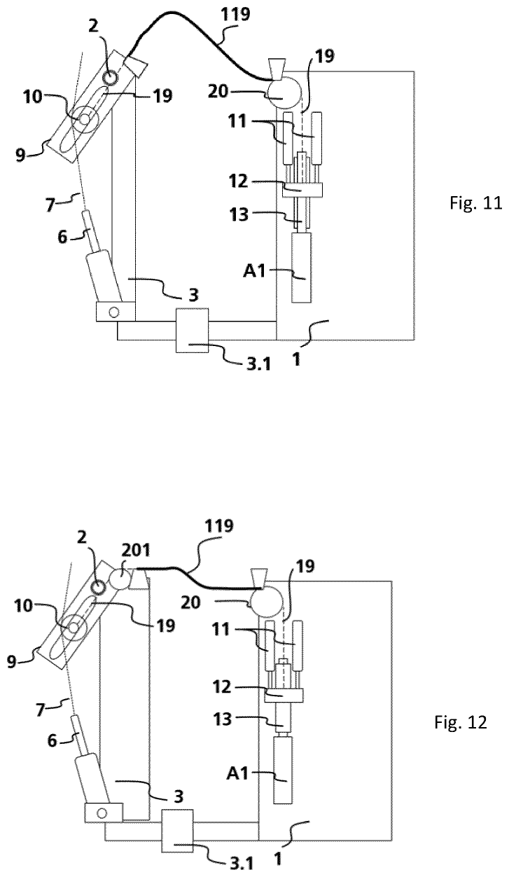

FIG. 11 shows further exemplary embodiments of the control mechanism;

FIG. 12 shows further exemplary embodiments of the control mechanism;

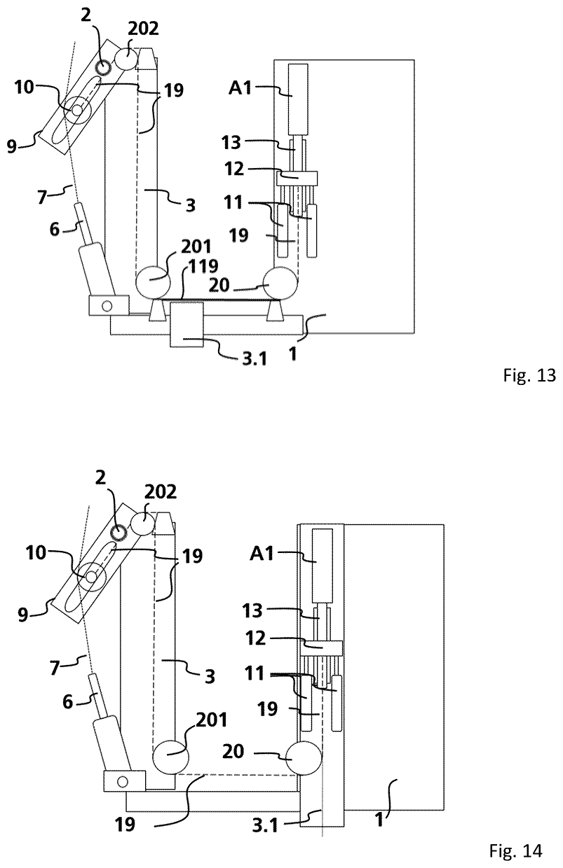

FIG. 13 shows further exemplary embodiments of the control mechanism;

FIG. 14 shows further exemplary embodiments of the control mechanism;

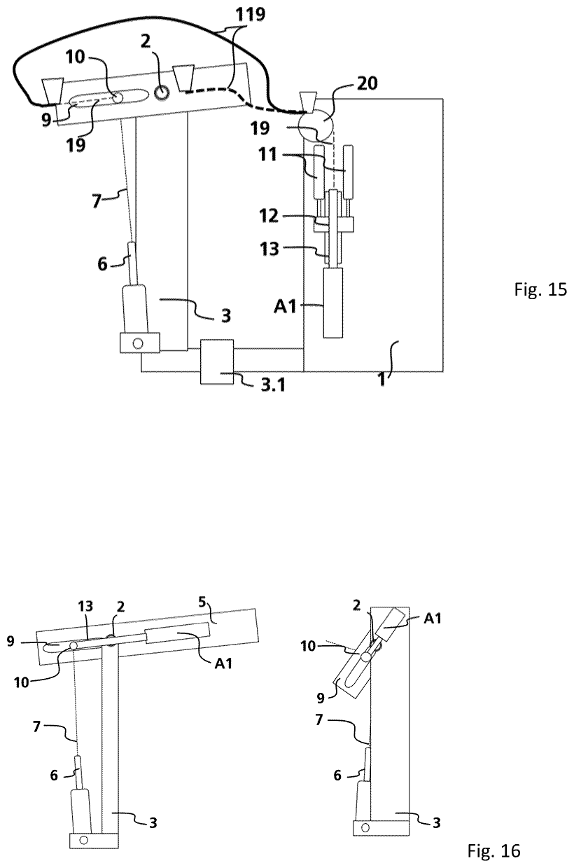

FIG. 15 shows further exemplary embodiments of the control mechanism; and

FIG. 16 shows further exemplary embodiments of the control mechanism.

FIG. 1 shows an exemplary embodiment of an extremity support device according to the invention for supporting an extremity of a user, this being an arm of the user here. The device comprises an extremity engagement unit 4, which is configured to engage on the arm of the user. The extremity engagement unit 4 is connected to an extremity lever 5 via an engagement connecting device 4.1, here, for example, a swivel joint or a screw connection, in combination with a prismatic joint (displaceability in the direction of the extremity lever 5). The extremity engagement unit 4 is configured as a cuff here, which can enclose the arm of the user. For this purpose, it comprises a lower curved bearing portion and an upper curved portion, which together form a cylindrical surface. It may be possible to open the cuff so that the user can place his or her arm therein. In the simplest case, the engagement connecting element 4.1 can also simply be an attachment by way of which the arm engagement unit 4 is attached to the extremity lever 5. If the extremity lever 5 and the extremity engagement unit 4 are monolithically produced, the connecting region between the part acting as the extremity engagement unit and the part acting as the extremity lever can also be regarded as the engagement connecting element 4.1.

The extremity lever 5 has an elongated configuration here and comprises an intermediate element 5.1, by way of which it is connected to a swivel joint 2. The extremity lever 5 can be rotated about the swivel joint 2. The extremity support device furthermore comprises a pull transmission element 7, which here is a cable pull 7, which engages on the extremity lever 5 on a side of the extremity lever 5 which is located opposite the engagement connecting element 4.1 in relation to the swivel joint 2. The pull transmission element 7 engages on the extremity lever 5 at a further intermediate element 5.2. The intermediate element 5.2 is to be considered to be part of the extremity lever 5. In the shown example, the intermediate element comprises a rail in which the point of engagement of the pull transmission element 7 can be displaced in a direction perpendicular to the longitudinal axis of the extremity lever 5 and can be fixed. In this way, the pull action of the pull transmission element 7 on the extremity lever 5 can be adjusted. The extremity support device furthermore comprises a spacer element 10, which limits, in at least one direction, which here is the direction away from the swivel joint 2, a distance between the pull transmission element 7 and the swivel joint 2 at the point of contact of the pull transmission element 7 with the spacer element 10.

The spacer element 10 can be moved by means of a control mechanism for varying a spacer element distance H1 between the spacer element 10 and the swivel joint 2. The control mechanism is in part hidden here in a connecting element 3 and will be described in detail in the following figures. In the example shown in FIG. 1, the connecting element 3 connects the swivel joint 2 to a torso module 1, which is configured to engage on the torso, which in the shown example is on the pelvis of the user. In the shown example, the connecting element 3 is configured as an elongated cuboid, which is connected via joints to the torso module 1 so that the extremity engagement unit 4 can be rotated about a connection point of the connecting element 3 to the torso module 1. In this way, the user is able to move his or her arm freely in the corresponding degrees of freedom.

The end of the pull transmission element 7 which does not engage on the extremity lever 5 is coupled to a passive actuator 6, which is configured to exert a pulling force on the pull transmission element 7. The pulling force is transmitted from the passive actuator 6 to the extremity lever 5 by way of the pull transmission element 7. In this example, a connection 3 exists between the torso module 1, which is a pelvic mount or a pelvic module 1 here, and the swivel joint 2. The swivel joint 2 is preferably positioned close to the shoulder, preferably in such a way that the rotational axis thereof extends through the glenohumeral joint. However, depending on the concept of the exoskeleton, a position in front of and behind there, as well as thereabove or therebeneath, is also possible. The connecting element 3, which also acts as a drive column here, connects the pelvic module 1 to the swivel joint 2. Torque around the swivel joint 2 is generated by the passive actuator 6, which here can be a spring element, a gas tension spring or a mechanical spring, for example, whereby a force is transmitted via the extremity lever 5 and the arm engagement unit 4 to the arm of the user. The extremity lever 5 is mounted so as to be rotatable about the swivel joint 2. The passive actuator 6 is preferably arranged close to the connecting element 3 so as to keep the dimensions of the extremity support device low. The lower end of the passive actuator 6 can vary, but should preferably be arranged distally from the swivel joint 2 so that the same does not yet collide with the guide element 9 when stretched. In the example shown in FIG. 1, the extremity support device comprises a guide element 9, along which the spacer element 10 can be moved for varying the spacer element distance H1. The guide element 9 can be fixed or fixable in relation to the control mechanism and/or the extremity lever 5 can be rotatable in relation to the guide element 9. In the shown example, the guide element 9 comprises a rail in which the spacer element 10 can be moved. In the shown example, the rail extends in a straight manner and radially with respect to the swivel joint 2. The rail has two opposing elongated holes, in which the spacer element engages with pins or rolls, so as to be held by the elongated holes.

As mentioned, the pull transmission element can, for example, be a cable pull, a pull rope or a rope, for example a wire rope or another cable pull made of plastic materials or natural materials, belts, chains and the like. The pull transmission element 7 is guided over the spacer element 10 up to the point of engagement at the extremity lever 5.

The resulting force on the extremity lever 5 is generated by the spring element 6 and possibly remains approximately the same, depending on the spring. The spacer element distance h1 of the engaging force vector in the cable direction to the swivel joint 2 can be varied, whereby the resulting torque around the swivel joint 2 or the resulting force on the arm engagement unit 4 changes. The position of the spacer element 10 in the guide element 9 is responsible for this distance. If the distance H1 between the spacer element 10 and the swivel joint 2 is smaller, the supporting force in the arm engagement unit 4 becomes smaller. This is shown in FIG. 1 on the right. If the distance H1 is larger than shown in FIG. 1 on the left, the force acting on the arm engagement unit is also larger. The distance H1 can be decreased to zero so that the resulting force becomes equal to zero, and the support is completely deactivated. In some circumstances, it may even become negative, whereby the arm is not pushed upwardly, but is pulled downwardly. The further the spacer element 10 is located away from the swivel joint 2, the greater is the action of the virtual lever arm H1, and thus of the force, on the arm engagement unit 4.

FIG. 2 shows several of the elements shown in FIG. 1, wherein, however, the extremity lever 5 and the arm engagement unit 4 as well as the torso module 1 and the connecting element 3 are not shown for the sake of clarity. Partial FIG. 2A shows a state in which the support is completely deactivated, partial FIG. 2B shows a state of maximum support, and partial FIG. 2C shows a control mechanism that in FIG. 1 is arranged in the interior of the connecting element 3.

The control mechanism shown in FIG. 2C comprises a control actuator 16, which includes a rotary drive A1 by which a spindle shaft 13 can be rotated. As is apparent in FIGS. 2A and 2B, a spindle nut 12 runs along a guide rod 14 on the spindle shaft 13. The guide rod 14 prevents the spindle nut 12 from rotating so that the nut, during the rotation of the spindle shaft 13, moves along this shaft. A control pull transmission element 19 is connected, on the one hand, to the spindle nut 12 and, on the other hand, to the spacer element 10. When the rotary drive A1 exerts torque on the spindle shaft 13, the spindle nut 12 moves in the direction of the rotational axis of the spindle shaft 13 and pulls or loosens the control pull transmission element 19. As a result, the spacer element 10 is displaced in the guide element 9. In FIG. 2A, the spindle nut 12 is arranged in the lowermost position so that the spacer element 10 is arranged in the position thereof closest to the swivel joint 2, whereby the support is completely deactivated in the shown example. The degree of support is thus zero here. In the state shown in FIG. 2B, the spindle nut is arranged at the uppermost position thereof, whereby the spacer element 10 is located the largest distance H1 from the swivel joint 2. The degree of support is thus maximal here.

In the interior of the connecting element 3, one or more elastic elements 11, which here are spring elements 11 (preferably gas pressures springs, or alternatively pretensioned or regular mechanical springs), are connected to the guide element 9, which here is an adjusting rail. The other ends of these spring elements 11 are connected (directly or via intermediate components) to the spindle nut 12. The guide 14 prevents the spindle nut 12 from rotating during the rotation of the spindle shaft 13. The spindle nut 12 is thus displaced along the spindle shaft 13 during the rotation of the spindle shaft 13. The spindle shaft 13 and the spindle nut 12 are preferably a ball screw spindle; however, trapezoidal spindles or other low-friction spindles are also possible. It is also possible for the control mechanism to comprise one or more drums, onto which at least one pulling force-transmitting element, for example a cable pull, can be wound and from which at least one pulling force-transmitting element can be unwound.

The spindle shaft 13 is, in turn, mounted in a bearing block 15 and connected to a drive shaft of the rotary drive A1, which can be an electric motor, for example. Further elements can be interconnected, such as brakes 17, which are also referred to as blocking elements 17, and/or couplings 18. The order of the blocking elements 17 and couplings 18 is arbitrary. When the drive A1 is activated, the spindle shaft 13 rotates, and the spindle nut 12 moves upwardly, thereby compressing the spring elements 11. The spring elements can also be conversely arranged so as to be expanded, when embodied as tension springs. The spindle nut 12 is directly or indirectly connected to a control pull transmission element 19 here, which is implemented by means of cable pulls 19 here. The control pull transmission element 19 runs over a deflection element 20, for example a cable pulley 20. At the deflection element 20, the control pull transmission element 19 changes the progression thereof in the direction of the spacer element 10 and, behind the deflection element 20, runs almost parallel to the adjustment direction of the spacer element 9 or to the progression of the rail of the guide element 9. The control pull transmission element 19 is connected to the spacer element 10. When the spindle nut 12 is moved upwardly, the required cable pull 19 in the drive column is shortened, whereby the spacer element 10 can slide toward distal in the guide element 9, whereby, in turn, the distance with respect to the swivel joint 2 increases.

This process can last from less than one second to several seconds, depending on the power of the rotary drive of the control actuator 16. Hereafter, this process shall also be referred to as “activation.” If a switchable coupling 18 is present in the control actuator, this coupling is closed during activation so that torque can be transmitted from the rotary drive to the spindle nut 12. In the activated state, that is, when the support is switched on, furthermore the blocking element 17, for example a permanent magnet brake, in the control mechanism can be activated. This makes it possible to shut the rotary drive off, and to open the coupling 18, since the blocking element 17 secures the spindle shaft 13 against back-rotation. In this state, the system can only be used completely passively, that is, no power whatsoever is consumed. The control mechanism comprises the control actuator 16. Optionally, the control mechanism may be identical to the control actuator. However, the control mechanism can also include further elements, such as a guide rail, for example, along which the spindle nut runs and which prevents the rotation thereof.

If the extremity support device is to be deactivated, the spacer element distance H1 between the swivel joint 2 and the spacer element 10 is reduced to almost zero, or to zero. If the described coupling 18 is provided, the deactivation can take place without any delaying back-rotation of the rotary drive A1. When the coupling 18 is opened, and possibly the blocking element 17 is opened, the pretensioned elastic elements 11 can passively push the spindle nut 12 downwardly (“back driving”), without consuming power. This process can take place very quickly, for example faster than in one second. Additional damping elements may be present so as to decelerate the spindle nut 12 in the spindle end positions. In the deactivated state, the system again does not require any power and is operated passively. In the example shown in FIGS. 1 and 2, the spacer element 10 is guided by the guide element 9, and the guide element 9 is fixed in relation to the connecting element 3. The guide element 9 is independent of a movement of the extremity lever 5. The pull transmission element 7 guided over the spacer element 10 thus always pulls the same toward distal or away from the swivel joint 2.

The extremity support device can be activated, for example, by external sensory pulses, for example a button can be pushed, an external load can be detected, for example by force and/or pressure sensors, or by muscle activity signals, which are measured by way of EMG, for example. It is also possible to recognize tools and loads by way of proximity sensors, such as RFID transceivers. The degree of support, that is, the spacer element distance, can be continuously adjusted. Force/pressure sensors can be arranged between the person and the external load, or between the person and the exoskeleton mount, that is, for example, at the extremity engagement unit 4. It is also possible to vary the degree of support manually using simple controllers, such as potentiometers, for example. The degree of support can be adjusted live prior to or during each activity.

Typical work scenarios during which the extremity support device according to the invention can be used can be as follows, for example:
Scenario 1—carrying and lifting: A user wears the system in the deactivated state and picks up a load after having set the support, for example, to 100% because he or she has to carry a heavy load. When picking up the load, he or she presses a button, thereby completely activating the system within 2-3 seconds (time is provided by way of example, possibly shorter or longer). Meanwhile, the user can already walk to the target location, wherein the degree of support is increased over the 2-3 seconds, and the user is thus provided relief during carrying. The system is now (activated) in a passive state in which no energy is being consumed. The user can arrive at the target location and lift the load with full support to a raised position. After setting down the load, the user releases the button, thereby completely deactivating the system again in less than 1 second (for example 0.5 seconds). The short time for deactivation is useful since the arms of the user are then not pushed upwardly for an unnecessarily long time. He or she can essentially move freely again immediately. Of course, the user does not have to deactivate the system. He or she can, for example, also lift a load down from a raised surface or carry the load. Generally speaking, the user can leave the system activated when he or she, for example, carries out restacking work. Or he or she can activate the system by pushing the button before lifting down a load, and can deactivate it again after having lifted the load down. Moreover, the user can make an infinite selection of the degree of support, for example by way of an electronic slide controller, and thus adapt it to the weight to be carried.
Scenario 2—overhead work: A user carries out overhead work during which he or she regularly has to reach for tools or parts. The system is activated during overhead working. When the user changes the tool, the system registers (for example via RFID) which tool is being used and adapts the degree of support to the weight. The user can deactivate the system, for example by pushing a button (button at the finger), when he or she desires to lower the arms, when he or she, for example, changes the location or has to pick up a tool/part. As mentioned, this essentially takes place in real time.

FIG. 3 schematically shows a part of an extremity support device according to the invention to explain the progression of the pull transmission element 7 at different angular positions of the extremity lever 5. FIG. 3A shows the extremity lever 5 with a large angle 3 between the connecting element 3 and the extremity lever 5. As in FIG. 2, the pull transmission element 7 runs from the passive actuator 6 to the spacer element 10 to a part 8 of the extremity lever 5 which faces away from the extremity engagement unit 4 (not shown). The pull transmission element 7 runs between the spacer element 10 and the swivel joint 2 and makes contact with the spacer element 10. As viewed proceeding from the passive actuator 6, the pull transmission element 7 changes the progression thereof at the spacer element 10 in the direction away from the swivel joint 2. At the location at which the pull transmission element 7 makes contact with the spacer element 10, the spacer element 10 thus limits the distance of the pull transmission element 7 in the direction away from the swivel joint 2. The pull transmission element 7 thus pushes the spacer element 10 toward distal, that is, away from the swivel joint 2, over large angular ranges of P and is limited toward distal by the position of the spacer element 10 in the adjusting rail 9. This results in a forced distance and lever arm with respect to the swivel joint 2. As is apparent from FIG. 3B, however, an angular range P also exists in which the pull transmission element 7 does not make contact with the spacer element 10, and the resulting force does not point toward distal, but toward proximal. This is the range in which β is sufficiently small. Here, the spacer element 10 has no influence on the lever arm H1 of the extremity lever 5, and thus on the supporting torque.

The state shown in FIG. 3B is not necessarily problematic. However, if there is a desire for the spacer element 10 to have an influence also at small angles β, different solutions are conceivable. Several advantageous solutions are shown in FIG. 4. FIG. 4A shows a solution in which the pull transmission element 7 comprises a first pull transmission sub-element 7.1 and a second pull transmission sub-element 7.2. The pull transmission sub-elements 7.1 and 7.2 can also be sections of the shared pull transmission element 7 when the same is configured as a loop, for example. The one pull transmission element 7.1 runs, proceeding from the passive actuator 6, past the spacer element 10, on the side thereof facing away from the swivel joint 2, to the end 8 of the lever 5 which faces away from the extremity engagement unit 4. The other pull transmission sub-element 7.2 runs from the passive actuator 6 between the spacer element 10 and the swivel joint 2 to the end 8 of the extremity lever 5. Here, as is shown in FIG. 3, the pull transmission sub-element 7.2 acts at large angles β. In FIG. 4A, the extremity lever 5 is in a position having small angles β, where, as is shown in FIG. 3B, the pull transmission element 7.2 is not yet limited by the spacer element 10. However, in this state, in FIG. 4A, the outer pull transmission element 7.1 runs past the spacer element 10, makes contact therewith, and changes the direction of the progression thereof at the spacer element 10 in the direction toward the swivel joint 2. The pull transmission sub-element 7.1 thus engages at the end 8 of the extremity lever 5 at a larger angle than in the case shown in FIG. 3B. As a result, sufficient support of the user can be ensured even at small angles β. In the shown example, the pull transmission sub-elements 7.1 and 7.2 are cable pulls. In addition to cable pull 7.2, there is the second cable pull 7.1, which grips the spacer element 10 from the other side, whereby it is also possible to absorb forces toward proximal toward the swivel joint 2. 7.2. is shown with exaggerated slack here to illustrate which cable pull transmits the forces. When the angle β increases, 7.1 would become slack starting at a certain angle, and 7.2 would be tensioned and transmit the forces. 7.1 and 7.2 could also be a single pulling element, which is designed as a loop that is guided through an attachment in 6 and 8. In this case, the illustration of 7.2 would also be tensioned in this position.

The pull transmission sub-element 7.1 exerts a force in the proximal direction on the spacer element 10 here. If the pull transmission sub-elements 7.1 and 7.2 are sections of a single pull transmission element 7 that is configured as a loop, the pull transmission element 7.2 could also be tensioned in the position shown in FIG. 4A. In the form of a loop, the pull transmission element 7 could, for example, be guided by an attachment at the passive actuator 6 and at the furthest end 8 of the extremity lever 5.

FIG. 4B shows another option for ensuring a certain minimum angle of engagement of the pull transmission element 7 on the extremity lever 5 in the case of small angles @ between the extremity lever 5 and the connecting element 3. Here, the spacer element 10 comprises two rolls, which are arranged next to one another in the direction of the guide element 9. In the shown example, the rolls have parallel rotational axes. The pull transmission element 7 runs from the passive actuator between the two rolls to the furthest end 8 of the extremity lever 5. In this embodiment, the spacer element 10 can limit the progression of the pull transmission element 7 in both directions, both away from the swivel joint 2 and toward the swivel joint 2. At small angles, the force on the pull transmission element 7 is thus exerted by the roll located closer to the swivel joint 2, and at large angles, it is exerted by the roll of the spacer element 10 located further away from the swivel joint 2. The embodiment of the spacer element 10 comprising two rolls shown in FIG. 4B can also be used in FIGS. 5, 6 and 7.

If the spacer element 10, as shown in FIGS. 4A and 4B, is to limit the distance between the pull transmission elements 7 and the swivel joint 2 even at small angles β, it is advantageous when the control mechanism makes it possible to exert a force for varying the spacer element distance H1 in both directions on the spacer element 10, that is, in the direction of the swivel joint 2 and in the direction away from the swivel joint 2. Numerous options exist for this, of which a simple one is shown in FIG. 4C, and another is shown in FIGS. 5 and 6. The spacer element 10 can absorb forces of the individual cable pull 7 toward distal and proximal, shown here by way of example, by way of the two coupled cable pulleys (other guides/deflection components that act on two sides are likewise possible).

In the example shown in FIG. 4C, the control pull transmission element 19 comprises two control pull transmission sub-elements 19.1 and 19.2, which can also be referred to as a first control pull transmission element 19.1 and a further control pull element 19.2. The first control pull transmission element 19.1 is connected, on the one hand, to the control actuator, here to the spindle nut 12, in such a way that a pulling force can be exerted on the first control pull transmission element 19.1 by the control actuator 16. On the other hand, the first control pull transmission element 19.1 is connected to the spacer element 10 in such a way that a force can be exerted on the spacer element 10 in the direction toward the swivel joint 2 by way of the first control pull transmission element 19.1. In the process, the first control pull transmission element 19.1, during the progression thereof from the spindle nut 12 to the spacer element 10, passes a deflection element 20.1. If the first control pull transmission element is, for example, a cable, a chain or a belt, the deflection element 20.1 can advantageously be a roller. At the deflection element 20.1, the control pull transmission element 19.1 changes the direction of the progression thereof in the direction toward the spacer element.

The further control pull transmission element 19.2 is connected to the spacer element 10 on a side of the spacer element 10 which is located opposite the first control pull transmission element 19.1, here, thus, on the side of the spacer element 10 which faces away from the swivel joint 2. The other end of the further control pull transmission element 19.2 is connected to the control actuator 16 in such a way that a pulling force, which is oriented opposite to the pulling force that is exerted on the first control pull transmission element 19.1, can be exerted on the further control pull transmission element 19.2 by the control actuator. In the example shown in FIG. 4C, the further control pull transmission element is thus arranged on the opposite side of the spindle nut 12. During the progression from the spacer element to the spindle nut 12, the further control pull transmission element 19.2 runs over two deflection elements 20.3 and 20.2. Proceeding from the spacer element 10, the further control pull transmission element 19.2 initially runs to the deflection element 20.3, where it changes the direction of the progression thereof in the direction of the deflection element 20.2, then runs to the deflection element 20.2, and at this element changes the direction of the progression thereof toward the spindle nut 12. If the spindle nut 12 now moves upwardly, the further control pull transmission element 19.2 pulls the spacer element 10 away from the swivel joint 2. If the spindle nut 12 moves downwardly, the control pull transmission element 19.1 pulls the spacer element 10 in the direction of the swivel joint 2. The deflection elements 20.2 and 20.3 can be rollers as well. However, any rounded surfaces can also be used for all deflection elements 20.1, 20.2, 20.3.

The additional deflection elements 20.2 and 20.3 and the pull elements 19.1 and 19.2 position the spacer element 10 in the adjusting rail 9 so that the element is able to absorb forces acting toward proximal and distal. Cable pulls are shown in dashed lines, and hidden contours of the deflection rollers (here representatively for deflection elements 20.1, 20.2 and 20.3 and the spacer element 10) are shown in dotted lines.

FIG. 5 shows further exemplary embodiments of a control mechanism including force transmission from the control actuator 16 to the spacer element 10. The extremity lever 5, including the components thereof, are hidden in these figures for the sake of clarity.

The embodiments shown in FIGS. 5A, 5B, 5C, 5D have in common that the control actuator 16 is configured as a rotary drive A1. In FIGS. 5A, 5B and 5D, the spacer element 10 comprises a spindle nut 12, which is guided on a spindle shaft 13. Elastic elements 11 are tensioned or compressed during the movement of the spindle nut and can effectuate or support the return movement of the spindle nut. The embodiments of FIGS. 5A, 5B and 5D only differ in the manner in which the torque is transmitted from the rotary drive A1 to the spindle shaft 13. In FIG. 5A, this takes place via a bevel gear connection 21 comprising two mutually engaging bevel gears, the rotational axes of which are situated at the angle with respect to one another at which the guide element 9 is situated with respect to the rotational axis of the rotary drive A1. In FIG. 5B, the transmission is carried out via a universal joint connection 22, and in FIG. 5D, it is carried out via a worm gear 26/worm shaft 27 connection. In the example shown in FIG. 5D, it is advantageous when the angle between the guide element 9 and the rotational axis of the rotary drive 16 is 90°.

In FIG. 5C, the rotational movement of the control actuator 16 is transmitted by means of a gear wheel 24 to a toothed rack 25, which is connected to the spacer element 10, moving the same when the gear wheel 24 displaces the toothed rack 25. Elastic elements 11 can also be provided here. Here as well, the guide element 9 is preferably situated at a right angle with respect to the rotational axis of the control actuator 16.

FIG. 6A shows another option for varying the spacer element distance H1. This option is characterized by a very narrow design comprising few components. The spacer element 10 is, preferably directly or by way of a swivel joint, directly connected to the control actuator 16, in the shown example to the spindle nut 12 thereof, serving as the movable part. As a result of the rotary drive A1 of the control actuator 16 being rotated, the spindle nut 12 moves upwardly or downwardly, whereby the spacer element 10 also moves upwardly or downwardly. Consequently, the spacer element distance H1 between the spacer element 10 and the swivel joint 2 changes. However, it is also conceivable in FIG. 6A for the spacer element 10 to be moved via a second shaft, or a shaft linked via spur gears, which would be similar to the embodiments in FIG. 5.

FIGS. 6B and 6C show a further option of the force transmission from the control actuator 16 to the spacer element 10. In the example shown in FIGS. 6B and 6C, the spacer element 10 is connected to the control actuator 16, here the spindle nut 12 thereof, via a chain made up of straight, rigid connecting links 29, which are in each case connected via a swivel joint to the spindle nut 12 and the spacer element 10. Moreover, the connecting links 29 are, in turn, connected to one another via a swivel joint. The swivel joint between the connecting links 29 is guided in a rail 28, so that the swivel joint can only move along the rail 28. The rail 28 is inclined with respect to the rotational axis of the control actuator 16 in the direction of the guide element 9. When the spindle nut 12 moves upwardly, it pushes the joint in the rail 28 in the direction of the guide element 9, and the connecting link 29 arranged at the spacer element 10 thus pushes the spacer element 10 away in the direction of the swivel joint 2. When the spindle nut 12 moves downwardly, the aforementioned elements move in the opposite direction. FIG. 6B shows the state of the system with a spacer element 10 that is arranged close to the swivel joint, that is, having a low degree of support, while FIG. 6C shows the state with a spacer element 10 located far away from the swivel joint 2, that is, a large degree of support.

The connecting links 29 used in FIGS. 6B and 6C are rigid, that is, not flexible, components, which can be connected to one another, for example, via swivel joints or also ball joints or universal joints. Instead of guide rails 28, the joint can also be guided in a guide groove or in guide grooves 28.

FIGS. 7A and 7B, in turn, show a section of an extremity support device according to the invention. An angle α between the guide element 9 and the connecting element 3 or a rotational axis of the control actuator 16 can be differently large. Different angles α change the profile of the spacer element distance H1, and thus also the profile and the magnitude of the angle-dependent supporting torque (which depends on the angle β between the extremity lever 5 and the connecting element 3). Different profiles of the supporting torque may be desired for different activities, for example lifting, carrying, holding overhead, pushing or pulling. It may therefore be advantageously possible to set the angle α between the guide element 9, or the direction with which the guide element guides the spacer element 10, and the connecting element 3, or the rotational axis of a rotary drive A1 of the control actuator 16, for example via the articulated mount 30 of the guide element 9 shown in FIG. 7A, with the option of force-fit or form-locked fixation or locking at a defined angle α. This fixation option and the associated angles α for the embodiment of the invention shown in FIGS. 1 and 2 are shown in FIG. 7A, but may also be used in the other embodiments of the invention.

As is shown in FIG. 7B, it is not absolutely necessary for the guide element 9 to guide the spacer element 10 along a straight path. In FIG. 7B, the guide element 9 has a curved guidance, which is strictly monotonically curved here. In this way, an even greater variance can be introduced in the angle-dependent supporting torque profile. By adjusting the control actuator 16, for example, an even greater change in the degree of support or in the moment characteristic is possible. The rail of the guide element 9 can, for example, be curved so as to take on a profile of the supporting torque (depending on P) in the lower support range which corresponds to a small angle of a (for example 30°), and a profile of the supporting torque (depending on P) in the upper support range which corresponds to a larger angle of α (for example 60°).

FIG. 7C, by way of example, shows a part of an extremity support device according to the invention, in which the control actuator 16 comprises a rotary drive A1, the rotation of which is transmitted to the spindle shaft 13 via two mutually engaging gear wheels 31 having parallel axes. The rotary drive A1 is arranged next to the spindle shaft 13, that is, in the direction of the connecting element 3 at the same height. In this way, the length of the control actuator 16 can be reduced in the longitudinal direction of the connecting element 3.

In further alternative designs, parts of the control actuator 16 and of the control mechanism (that is, all further elements between the spacer element 10 and the control actuator 16) can also be arranged in a different location. For example, as shown in FIG. 8A, the guide element 9 can also be arranged in the end 8 of the extremity lever 5 which faces away from the extremity engagement unit 4 minus the swivel joint 2 and, for example, can run parallel to the longitudinal direction of the extremity lever 5. In FIG. 8A, the spacer element 10 is thus guided along the longitudinal direction of the extremity lever 5 in region 8. Since the spacer element 10 is to be moved in both directions here by pulling forces, the pulling force transmission element 19 here again comprises a first pulling force transmission element 19.1 and a further pulling force transmission element 19.2, which are fixed on opposing sides of the spindle nut 12 and engage on the spacer element 10 on opposing sides. They are guided over deflection elements 20, for example rollers 20, so as to run parallel to the longitudinal direction of the rail of the guide element 9 in the region of the rail. In this example, the pull transmission element 7 is directly connected or attached to the spacer element 10. The deflection rollers 20 are specifically arranged in such a way that a deflection roller in the shown example is coaxial with respect to the swivel joint 20. A deflection roller arranged beneath the spindle nut 12 deflects the control pull transmission element 19.2 arranged at the bottom of the spindle nut in the direction of this roller, which is coaxial with respect to the swivel joint. The roller that is coaxial with respect to the swivel joint 2 then deflects the control pull transmission element 19.2 in the direction of a further deflection element, which is arranged on the end of the guide rail 9 which faces away from the swivel joint 2. This deflection element then guides the control pull transmission element 19.2, in a direction parallel to the longitudinal axis of the guide element 9, to the spacer element 10. The control pull transmission element 19.1 engaging on the top of the spindle nut 12 runs from there to a further deflection element 20 having a rotational axis that is coaxial with respect to the swivel joint 2, and is guided thereby, in a direction parallel to the longitudinal axis of the guide rail 9, to the spacer element 10.

In FIG. 8A, the cable pull 19.1 is released when the spindle nut 12 moves upwardly in the adjusting rail 9, so that the spacer element 10 migrates toward distal. At the same time, the control pull transmission element 19.2 is shortened, likewise pulling the spacer element 10 toward distal. By suitably arranging the deflection element 20, this can be ensured regardless of the angle β. Advantageously, the control pull transmission element 19 can also have a slightly elastic design here so as to compensate for smaller differences between released and shortened control pull transmission elements 19, which may occur, for example, when the angle β changes as a result of these rolling on or rolling off the deflection elements. For example, the control pull transmission elements 19.1 and 19.2 can be configured as slightly elastic cables here. The embodiment shown in FIG. 8A can also be implemented with the transmission options shown in FIGS. 5 and 6, instead of using control pull transmission elements 19.1 and 19.2, that is, for example, with mechanically guided components, as in FIGS. 6B and 6C, or with cardan joints, as in FIG. 5C.

Similarly to FIG. 8A, FIG. 8B shows an embodiment in which the guide element 9 is part of the end 8 of the extremity lever 5 which faces away from the extremity engagement unit 4. However, here, the control actuator 16 is arranged in the extremity lever 5, wherein the rotational axis thereof is situated parallel to the longitudinal direction of the extremity lever 5. The spindle nut 12 thus moves in the direction of the longitudinal direction of the extremity lever 5 on the spindle shaft 13, tensioning or compressing the elastic elements 11, which are likewise situated parallel to the longitudinal direction of the extremity lever 5. In this embodiment, the pull transmission element 7 can be arranged and attached directly at the movable part of the control actuator 16, which here is at the spindle nut 12. This embodiment is advantageous since angular dependencies on the angle β are avoided here. A rotary drive A1 of the control actuator 16 as well as the two elastic elements 11 are arranged on the side of the extremity lever 5 which includes the arm engagement unit 4, that is opposite the guide element 9 in relation to the swivel joint 2. The spindle nut 12 runs along the guide element 9.

In the example shown in FIG. 8B, the spring elements 11 can also be arranged in the extremity lever 5 so as to enable rapid deactivation. If the rotary drive A1 is angled with respect to the extremity lever 5, it is also possible to use the above-described elements for deflecting the force, that is, for example, cardan joints, bevel gears and the like, as is shown in FIGS. 5, 6 and 9. It is also possible to use cable pulls, for example by means of several cable pulleys 20, which can fix the position of the spacer element 10 in the guide element 9. FIGS. 9A and 9B, by way of example, show such an angled position of the control actuator 16 in relation to the guide element 9 and the transmission of the torque from the rotary drive A1 of the control actuator 16 via mutually engaging bevel gears 21 in FIG. 9A and via universal joints 22 in FIG. 9B. Here, the elastic elements 11 can advantageously be arranged in the part of the extremity lever 5 which also comprises the guide element 9 and can be situated parallel thereto.

It applies to all variants of the invention that variants of the design without a brake or blocking element 17 or coupling 18 can also be operated. In a more favorable or smaller embodiment, the brake or the blocking element 17 can be dispensed with, for example, when the activity, for example, is so highly dynamic that the fixation is not worthwhile energetically or when no space is available for the brake 17. The drive A1 is then preferably permanently activated. The coupling 18 can also be dispensed with; in this case, the drive A1 rotates along as the spindle nut 12 is moved downwardly. The deactivation process is then not quite as fast. It is also possible to dispense with the spring elements 11 in the interior. However, during deactivation, the drive A1 then has to apply more torque/energy so as to bring the spindle nut 12 into the deactivation position against to the force acting from the outside (due to tension of the external supporting torque-generating spring element).

Generally speaking, all shown compression springs can also be embodied as tension springs (and vice versa) when these act/apply a force from the other side. For this purpose, the springs are arranged in the reverse manner and now, for example, pull on the spindle nut 12 from beneath instead of pushing on the spindle nut from above.

It is also possible in each case to reverse the direction of the force action of the force elements 11 (for example springs) on the spindle nut 12. In this way, for example, no pressure acts any longer from above on the spindle nut 12, but instead upward pulling action is present. This is possible by replacing compression springs 11 with tension springs 11 (or vice versa), without modifying the arrangement, or by selecting the same type of force element (compression spring remains compression spring), while reversing the arrangement, as described in the previous paragraph. The result is now that the process of activating can also be carried without a motor, since the springs 11 push the spindle nut 12 into the activated position. With this, very rapid activation is now possible. Accordingly, however, the deactivation is carried out against the spring force, that is, is supported by the drive A1, and thus takes slightly longer. This may be advantageous for work during which particularly rapid activation is required, while the deactivation time is less critical. This is the case, for example, with hip joint supports for lifting activities (off the ground). When a user wants to pick something off the ground, the system can remain deactivated until the user, while in the bent-over position, picks something off the ground. Then, however, the system should be activated very quickly and help the user while getting up. Thereafter, a slow deactivation can also take place in the upright position. However, this can also be useful during lifting, carrying, pushing or pulling activities, or other activities during which the shoulder and the upper extremities experience stress, depending on the particular activity.

Other drives, as an alternative to rotating electric motors, are also possible. These include electric linear drives, single-acting our double-acting (without additional spring elements in the drive column) pneumatic or hydraulic cylinders, or artificial (in particular pneumatic) muscles in all variants, whereby in each case the drive train A1 and the linearization part (for example the toothed rack or the spindle shaft) can be replaced by these. It is in particular useful to replace the rotary drive with a linear drive (of any form) when the same is completely accommodated in the drive column, the connecting element 3 or completely accommodated in the lever 5/connecting linkage. Moreover, rotating drives that are not driven by electrical current, but by other media, are also an obvious choice, such as hydraulic or pneumatic rotary drives or internal combustion engines. It shall also be pointed out here that, depending on the required degree of support, smaller or larger drives (and other components) can be used to possibly save space.

In principle, it shall also be noted that, even though the described mechanism and the method were described for an exoskeleton (extremity support device) supporting the arms or shoulders, and are particularly useful here, they can also be applied to other body regions. It is possible, for example, to use the same mechanism to vary the degree of support in the region of the hip or elbow (all other body regions, such as the knee, spinal column, wrists or ankles are also possible, if useful). Of course, smaller design adaptations must be carried out, and minor changes must be made to the dimensions and arrangement of certain components. The mechanism, however, generally speaking, describes the option of varying a torque/supporting torque when the origin of the torque is a force, and the distance with respect to the center of rotation is adjusted so as to vary the supporting torque.

In this regard, FIG. 10 shows, by way of example in a schematic illustration, an embodiment of the extremity support device according to the invention for the case that legs are the supported extremity, here the thighs of the user. The left sub-image shows the device on a user, while the right sub-image only shows the device itself. The device here comprises an extremity engagement unit 4 for each thigh, which is configured to engage on the thigh of the user. An extremity lever 5 is connected to the extremity engagement unit 4 via an engagement connecting element 4.1, which is a cable pull here. The extremity lever 5 can be rotated about a swivel joint 2. A pull transmission element 7, which engages on the extremity lever 5 on a side of the extremity lever 5 which is located opposite the engagement connecting element 4.1 in relation to the swivel joint 2, is pulled by a passive actuator 6. The device comprises a spacer element 10 here as well, which limits, in at least one direction, the distance between the pull transmission element 7 and the swivel joint 2 at the point of contact between the transmission element 7 and the spacer element 10. Here as well, the spacer element 10 is moved by means of a control mechanism for varying the spacer element distance H1 between the spacer element and the swivel joint. Here as well, the control mechanism comprises a control actuator 16, by means of which a force can be exerted on the spacer element 10 for varying the spacer element distance H1.

FIGS. 11 to 15 show embodiments of the invention in which the control actuator is arranged so as to be arranged at the back of the user when used as intended. As a result, the weight is attached closer to the body and is therefore subjected to fewer movements by the connected body parts. This results in lower forces of inertia and moment actions, which makes the system overall easier for the user. In FIGS. 11 to 14, the extremity lever 5 is hidden for the sake of clarity. However, it is nonetheless provided in these examples. In FIGS. 11 to 14, the connecting element is furthermore fixedly connected to the guide element, that is, is preferably connected non-rotatably or in an articulated manner.

In the embodiments of FIGS. 11 to 15, the drive train (for example a motor in conjunction with a coupling, brake (together denoted by D1), spindle shaft 13 and nut 12 or a hydraulic or pneumatic cylinder) is arranged at the back of the wearer or at the hip. The torso module 1 extends along the back and contains the drive train. Other locations (for example at the leg, at the stomach) are also possible. However, an arrangement behind the user at the height of the hip or back is particularly advantageous. The force there is transmitted via cable pulls 19, serving as control pull transmission elements 19, to the spacer element 10. The cable pulls 19 are guided, for example, in a Bowden cable sheath 119 to the spacer element 10, which is guided in a guide element 9, as in the corresponding other examples, and which, in turn, is attached to the connecting element 3. Preferably, above all pulling forces are transmitted which are directed, at the end, in the direction of the orientation of the guide element 9, as is shown in FIG. 11. Preferably, however, otherwise essentially no forces are transmitted from the drive train to the connecting element 3 that would possibly move the entire structure of this side (this becomes possible by way of the Bowden cable strand 19 in the Bowden cable sheath 119, which, in addition to the force transmitted by the cable pull, above all transmits reaction forces of the Bowden cable strand 19 parallel thereto). It is also possible for the one or more cable pulls to pass none, one or more deflection rollers. The Bowden cable sheath 119 also does not have to be guided close to the spacer element 10, but can possibly also engage on the connecting element 3 further away.

In FIG. 11, the Bowden cable sheath 119 is guided from one end of the drive train, at which the force for varying the spacer element distance can be effectuated, close to the guide element 9 in such a way that the pull element 19 leaves the sheath in the direction of the guide element 9. Before the control pull transmission element 19 enters the Bowden cable sheath 119 behind the drive train (contacted with the torso module 1 or a part connected thereto, and, on the side of the guide element 9, with the guide element 9 or a part connected thereto, symbolized by truncated cones), it runs over a deflection roller 20 in the shown example, which deflects it in the direction that the Bowden cable sheath 119 has at this end. The Bowden cable, serving as the control pull transmission element 19, then runs from the drive train to the spacer element 10, which here, for example, would be from the back to the side of the user when used as intended.

FIG. 12 shows an embodiment corresponding to that shown in FIG. 11, in which, however, an additional deflection roller 201 is attached to the end of the guide element 9 which faces the control pull transmission element 19, so as to effectuate a change in direction of the control pull transmission element 19 in the direction of the guide element 9.

FIG. 13 shows a variant in which the drive train is arranged opposite to the manner shown in FIGS. 11 and 12, and where, at the bottom, two deflection rollers 20 and 201, including a Bowden cable sheath 119 guided therebetween, guide the cable 19 to the connecting element 3, in/at which it is guided to a further deflection roller 202, which, in turn, sets the final direction in the orientation of the guide element 9. Various other connections, positionings and progressions of the control pull transmission element 19 between the torso module 1 and the guide element 9 or the spacer element 10 are possible. It is also possible for the drive trains at the torso module 1 to be oriented differently. For example, these may be situated perpendicular to the current orientation.

Possibly further or fewer deflection rollers may then be provided.

As an alternative, an implementation without Bowden cable sheaths is also possible when all cable pull elements 19 are guided from one deflection roller to another deflection roller 20, 201, 202, and so forth, all the way to the spacer element 10. Advantageously, however, distances between the individual deflection elements in the architecture should not vary during use. One example of this is shown in FIG. 14. Non-varying distances can be effectuated, for example, in that the axis of a possibly provided joint 3.1, about which the connecting element 3 here can rotate relative to the torso module 1, is located on one axis with the pull element 19 (proceeding from the nut 12). It is possibly useful here for the entire drive unit to likewise be mounted so as to be rotatable about the joint 3.1 relative to the torso module 1.

FIG. 15, by way of example, shows an embodiment that can be used for all variants in which the guide element 9 and the spacer element 10 are arranged in the extremity lever 5 itself. Here, the Bowden cable sheath 119 can engage from behind (solid line), from the front (dotted line) or on any other location, wherein in each case the direction of the exiting strand 19, serving as the control pull transfer element, is ideally shown in the direction of the guide element 9. As an alternative or in addition, additional deflection rollers 20 may be present, which change the progression of the control pull transmission element in this direction. Such devices can also be provided in the interior of the extremity lever 5.

All drives (motors, coupling, brake) as well as the linearization unit (for example spindle shaft) that are shown in the figures can also be replaced with linear motors or hydraulic or pneumatic cylinders. In particular in FIG. 8, for example, all parts visible there in the extremity lever 5 (except for the guide element 9 and the spacer element 10) can be replaced with a single hydraulic cylinder. This is shown by way of example in the left sub-image of FIG. 16. This is also possible in FIG. 9, for example. The hydraulic cylinder, serving as the drive A1, can replace the drive parts and still be connected via a cable pulley to the spacer element 10 or, in extension 9, be arranged so as to be oriented in the direction of 9, and thereby control the position of 10. This is shown by way of example in the right sub-image of FIG. 16. Of course, other positions and orientations of the hydraulic cylinder A1 are also possible again here if forces are accordingly transmitted thereby via deflection rollers and pull elements to 1.

The pull element 6, serving as a passive actuator 6, can also be arranged in the interior of the connecting element 3, for example, when the pull transmission element 7 is connected thereto via a deflection roller. The pull element 6 does not have to be a tension spring and can also be a compression spring, which is preferably arranged in the interior of the connecting element so as to be compressed when P decreases as shown in FIG. 3.

As a semi-passive system, the system combines the advantages of passive exoskeletons (low weight, low/no energy consumption) and active exoskeletons (high dynamic adapatability). The degree of support can be continuously adjusted from 0-100%, and complete deactivation may be possible, whereby the user can passively move freely. The adjustment furthermore takes place very quickly upon activation, and extremely quickly (<0.5 seconds) upon deactivation, whereby the user can be supported very dynamically in his or her activities, without having to wait a long time (for the activation) or having to remain in positions with the arms pushed upward (deactivation). Moreover, the design and the integration of the actuator system and further components are very space-saving and lightweight. The blocking element 17 allows the system to be supported passively without power consumption. In this way, it is possible to carry out both static work (for example overhead work) and highly dynamic work (lifting, carrying, pushing, pulling) using a single system, wherein the energy consumption and thus the weight are minimized due to the semi-passive nature. As a result of geometric parameters of the guide element 9 (for example angle α), furthermore the profile of the supporting torque can be easily varied so as to enable load case-specific support that satisfies the biomechanical demands. The separation of the force element and the driven adjustment of the degree of support also immensely improves the safety of the exoskeleton compared to fully active systems, in which the drive itself directly generates the supporting force or the supporting torque.

Technical fields of application are manual handling activities, such as carrying and lifting, but also pulling, pushing and overhead work wherever people perform physical (hard) labor. This applies in particular to the following areas: logistics, production, military, forestry, horticulture and landscaping, patient care and medicine, trades, and construction. For the first time, such an exoskeleton is able to support several biomechanically very different activities (lifting, carrying, pulling, pushing and overhead work) in a single system. Further applications for supporting other body areas are also conceivable (hip support, knee support, elbow support or the like) to support physical labor in general.

1-43. (canceled)

44. An extremity support device for supporting an extremity of a user, comprising:
an extremity engagement unit, which is configured to engage on the extremity of the user;
an extremity lever, to which the extremity engagement unit is connected via an engagement connecting element;
a swivel joint about which the extremity lever can be rotated;
a pull transmission element, which engages on the extremity lever on a side of the extremity lever which is located opposite the engagement connecting element in relation to the swivel joint; and
a spacer element, which limits, in at least one direction, a distance between the pull transmission element and the swivel joint at the point of contact between the pull transmission element and the spacer element,
with
the spacer element being movable by means of a control mechanism for varying a spacer element distance between the spacer element and the swivel joint, and
the control mechanism comprising a control actuator, by means of which a force can be exerted on the spacer element for varying the spacer element distance.

45. The extremity support device according to claim 44,
wherein an end of the pull transmission element which does not engage on the extremity lever engages on a passive actuator, which is configured to exert a pulling force on the pull transmission element, the pulling force being transmittable to the extremity lever by way of the pull transmission element.

46. The extremity support device according to claim 44, further comprising a torso module, which is configured to engage on the torso of the user, the control mechanism being arranged at the torso module, and extremity lever being rotatable about the swivel joint in relation to the torso module.

47. The extremity support device according to claim 44,
comprising a guide element along which the spacer element can be moved for varying the spacer element distance.

48. The extremity support device according to claim 47, wherein the guide element is connected via a guide joint to the control mechanism, the guide joint comprising a locking device, by way of which a rotation of the guide element about the guide joint can be locked.

49. The extremity support device according to claim 47, wherein the guide element comprises a rail by which the spacer element is guided, the rail being straight or curved.

50. The extremity support device according to claim 44, wherein the spacer element limits the distance between the pull transmission element and the swivel joint in a direction away from the swivel joint, and the force for varying the spacer element distance which can be exerted by the control mechanism on the spacer element can be exerted in a direction toward the swivel joint or in a direction away from the swivel joint.

51. The extremity support device according to claim 44, wherein the pull transmission element comprises a first pull transmission sub-element and a second pull transmission sub-element,
the first and second pull transmission sub-elements passing the spacer element on opposite sides, wherein the first and second pull transmission elements are dimensioned in such a way that at least one of the pull transmission sub-elements makes contact with the spacer element in any position of the extremity lever.

52. The extremity support device according to claim 44,
wherein the spacer element comprises one roll for each direction in which it limits the distance between the pull transmission element and the swivel joint, the pull transmission element making contact with the respective roll, when the same limits the distance, on the side which is opposite the direction in which the respective roll limits the distance between the pull transmission element and the swivel joint.

53. The extremity support device according to claim 44, wherein the swivel joint is fixedly connected to the control mechanism or the torso module via a connecting element, the connecting element being configured so as to run along the torso of the user when the user wears the extremity support device as intended, and a direction of the force action of the control actuator extending parallel to the progression of the connecting element.

54. The extremity support device according to claim 44, wherein the control actuator is arranged at the extremity lever on the same side in relation to the swivel joint as the extremity engagement unit, a direction of the force action of the control actuator extending parallel to a longitudinal direction of the extremity lever at the site where the control actuator is arranged.

55. The extremity support device according to claim 44, wherein the control actuator comprises a rotary drive, a spindle shaft that can be rotated by the rotary drive, and a spindle nut running on the spindle shaft, the force on the spacer element being effectuatable by the spindle nut.

56. The extremity support device according to claim 44, wherein the control mechanism comprises at least one elastic element, which is arranged so as to be deflectable by the control actuator, and causes a force that is oriented against to the force that can be exerted by the control actuator and causes the change in the spacer element distance.

57. The extremity support device according to claim 44, wherein the control actuator comprises a rotary drive, a linearization mechanism by way of which a torque effectuated by the rotary drive can be transformed into the force for varying the spacer element distance, and a coupling by way of which the transformation of the torque into the force can be established and released.

58. The extremity support device according to claim 44, wherein the control mechanism comprises at least one blocking element by way of which the spacer element distance between the spacer element and the swivel joint can be fixed.

59. The extremity support device according to claim 44,
wherein the control mechanism comprises a first control pull transmission element, the first control pull transmission element being connected, on the one hand, to the control actuator in such a way that a pulling force can be exerted on the first control pull transmission element by the control actuator, and the first control pull transmission element, on the other hand, being contacted with the spacer element in such a way that the force for varying the spacer element distance can be exerted on the spacer element by way of the first control pull transmission element.

60. The extremity support device according to claim 59, wherein the first control pull transmission element, during the progression thereof from the control actuator to the spacer element, passes at least one deflection element.

61. The extremity support device according to claim 60, wherein the control pull transmission element is guided in a Bowden cable sheath in at least a portion of the progression thereof.

62. The extremity support device according to claim 46, wherein the control actuator is arranged at the torso module so as to be arranged at the back of the user when the extremity support device is used as intended.

63. The extremity support device according to claim 59, comprising a further control pull transmission element, which is contacted with the spacer element on a side of the spacer element located opposite the first control pull transmission element, and which is connected to the control actuator in such a way that a pulling force, which is oriented opposite to the pulling force that can be exerted on the first control pull transmission element, can be exerted on the further control pull transmission element by the control actuator.

64. The extremity support device according to claim 63, wherein the control actuator comprises a rotary drive and a roll that can be rotated by the rotary drive, the control pull transmission element being attached to a surface of the roll so as to be able to be wound onto the roll and/or unwound from the roll by a rotation of the roll.

65. The extremity support device according to claim 44, wherein the spacer element is fixedly arranged directly at the control actuator.

66. The extremity support device according to claim 44,
wherein the control mechanism comprises a bevel gear connection, in which a first bevel gear can be driven by the control actuator, and a second bevel gear is connected to a spindle, the rotation of which allows the force for varying the spacer element distance to be exerted on the spacer element;
wherein the control mechanism comprises a universal joint connection, by means of which the force for varying the spacer element distance can be transmitted from the control actuator to the spacer element;
wherein the control mechanism comprises a gear wheel, which can be driven by the control actuator, and additionally a toothed rack in which the gear wheel engages, the toothed rack being connected to the spacer element so that the force for varying the spacer element distance can be transmitted by the toothed rack to the spacer element;
wherein the control mechanism comprises a worm gear that can be driven by the control actuator, as well as a worm shaft in which the worm gear engages, the worm shaft being connected to the spacer element so that the force for varying the spacer element distance can be transmitted by the worm shaft to the spacer element; or
wherein the control actuator comprises a rotary drive, a spindle shaft that can be rotated by the rotary drive, and a spindle nut running on the spindle shaft, the extremity support device furthermore comprising a chain made of at least two links connected to one another via connecting joints, of which a first of the links engages on the spindle nut, and a last of the links engages on the spacer element.

67. The extremity support device according to claim 44,
wherein the control actuator comprises a rotary drive and a shaft, which are arranged next to one another and with rotational axes parallel to one another and which are kinematically connected to one another via a gear mechanism;
wherein the control actuator comprises at least one hydraulic cylinder; or
wherein the extremity support device further comprising a displacement element attached to the extremity lever, and the pull transmission element being fixedly connected at one of the ends thereof to the displacement element, the displacement element being displaceable at the extremity lever in a plane that is perpendicular to the rotational axis, along a longitudinal direction of the extremity lever, and/or in a direction perpendicular to the longitudinal direction of the extremity lever.

68. The extremity support device according to claim 44,
comprising a switch and/or a slide controller by means of which the spacer element distance can be adjusted;
comprising a proximity sensor, a force sensor and/or a pressure sensor, which is configured to detect a weight of a load to be picked up, the control mechanism being configured to adjust the spacer element distance based on the detected weight;
comprising a muscle activity signal sensor, which can be used to measure activity signals of at least one muscle of the extremity, the control mechanism being configured to adjust the spacer element distance based on the measured activity signal;
wherein the extremity is an arm of the user, and the extremity support device is an arm support device or a shoulder support device;
wherein the pull transmission element is attached to the extremity lever on the side of the extremity lever which is located opposite the engagement connecting element in relation to the swivel joint; or
wherein the pull transmission element and/or the control pull transmission element comprises or is at least one cable and/or one chain and/or at least one belt.

69. A method for lifting, holding and/or carrying a load and/or for carrying out overhead activities, wherein a user wears an extremity support device according to claim 44, and, with support from the extremity support device, lifts the load, holds it and/or carries it and/or carries out an activity with his or her hands raised above the height of the head.

70. The method according to claim 69, wherein the spacer element distance prior to and/or while lifting, holding or carrying and/or carrying out the activity with the hands raised above the height of the head is set to a first value, the user thereafter lifts the load, holds it, carries it and/or carries out the activity with the hands raised above the height of the head, the user then sets the load down, and thereafter the spacer element distance is set to a second value, which is smaller than the first value.

71. The method according to claim 70,
wherein the control actuator is activated while the spacer element distance is set to the first value, and is deactivated for setting the second value; or
wherein the control actuator comprises a rotary drive, a linearization mechanism by way of which a torque effectuated by the rotary drive can be transformed into the force for varying the spacer element distance, and a coupling by way of which the transformation of the torque into the force can be established and released,
before the spacer element distance is set to the first value, the transformation of the torque into the force between the rotary drive and the spacer element being established by way of the coupling, and
the transformation of the torque into the force by the coupling being released for setting the spacer element to the second value.

72. The method according to claim 71,
wherein the control mechanism comprises at least one blocking element by way of which the spacer element distance between the spacer element and the swivel joint can be fixed,
the spacer element distance being fixed by way of the blocking element after the spacer element distance has been set to the first value, and the blocking element being released for setting the spacer element distance to the second value.

73. The method according to claim 69,
wherein the control actuator comprises a rotary drive, a linearization mechanism by way of which a torque effectuated by the rotary drive can be transformed into the force for varying the spacer element distance, and a coupling by way of which the transformation of the torque into the force can be established and released, and
wherein the control mechanism comprises at least one blocking element by way of which the spacer element distance between the spacer element and the swivel joint can be fixed,
before the spacer element distance is set to the first value, the transformation of the torque into the force between the rotary drive and the spacer element being established by way of the coupling,
the spacer element distance being fixed by way of the blocking element after the spacer element distance has been set to the first value, and the blocking element and the coupling being released for setting the spacer element distance to the second value.
